(19) United States
(12) Patent Application Publication
(10) Pub. No.: US 2007/0278788 A1
(43) Pub. Date: Dec. 6, 2007

(54) Protective compression and tension sleeves for threaded connections for radially expandable tubular members

(75) Inventor: Scott Costa, Kingwood, TX (US)

Correspondence Address: Todd Mattingly;King & Spalding LLP, Suite 4000, 1100 Louisiana Street, Houston, TX, 77002, US

(73) Assignee: Enventure Global Technology, Houston, TX (US)

(21) Appl. No.: 10/546,078

(22) Filed: Aug. 17, 2005

Related U.S. Application Data
(63) Continuation of application No. PCT/US04/04740, filed on Feb. 17, 2004.
(60) Provisional application No. 60/448,526, filed on Feb. 18, 2003.

(51) Int. Cl. F16L 21/00

(52) U.S. Cl. 285/235

(57) ABSTRACT

A radially expandable multiple tubular member apparatus includes a first tubular member and a second tubular member engaged with the first tubular member forming a joint. A sleeve overlaps and couples the first and second tubular members at the joint.

### CROSS REFERENCE TO RELATED APPLICATIONS

The present application is the National Stage patent application for PCT patent application serial number PCT/US2004/004740, attorney docket number 25791.185.02, filed on Feb. 17, 2004, which claimed the benefit of the filing dates of (1) U.S. provisional patent application Ser. No. 60/448,526, attorney docket no. 25791.185, filed on Feb. 18, 2003, the disclosures of which are incorporated herein by reference.

The present application is a continuation in part of U.S. utility patent application Ser. No. 10/528,222, attorney docket no. 25791.129.03, filed on Mar. 20, 2005, which was the National Stage patent application for PCT patent application serial no. PCT/US03/25716, filed on Aug. 18, 2003, attorney docket no. 25791.129.02, which was a continuation in part of U.S. utility patent application Ser. No. 10/528,223, attorney docket no. 25791.127.03, filed on Mar. 18, 2005, which was the National Stage patent application for PCT patent application serial no. PCT/US03/25707, filed on Aug. 18, 2003, attorney docket number 25791.127.02, which was a continuation in part of U.S. utility patent application Ser. No. 10/525,402, attorney docket no. 25791.120.05, filed on Feb. 23, 2005, which was the National Stage patent application for PCT patent application serial no. PCT/US03/25676, filed on Aug. 18, 2003, attorney docket number 25791.120.02, which was a continuation in part of U.S. utility patent application Ser. No. 10/525,332, attorney docket no. 25791.119.03, filed on Feb. 23, 2005, which was the National Stage patent application for PCT patent application serial no. PCT/US03/25677, filed on Aug. 18, 2003, attorney docket number 25791.119.02, which was a continuation in part of U.S. utility patent application Ser. No. 10/522,039, attorney docket no. 25791.106.05, filed on Jan. 19, 2005, which was the National Stage patent application for PCT patent application serial no. PCT/US03/19993, filed on Jun. 24, 2003, attorney docket number 25791.106.02, which was a continuation in part of U.S. utility patent application Ser. No. 10/511,410, attorney docket no. 25791.101.05, filed on Oct. 14, 2004, which was the National Stage patent application for PCT patent application serial no. PCT/US03/10144, filed on Mar. 31, 2003, attorney docket number 25791.101.02, which was a continuation in part of U.S. utility patent application Ser. No. 10/510,966, attorney docket no. 25791.93.05, filed on Oct. 12, 2004, which was the National Stage patent application for PCT patent application serial no. PCT/US03/06544, filed on Mar. 4, 2003, attorney docket number 25791.93.02, which was a continuation in part of U.S. utility patent application Ser. No. 10/500,745, attorney docket no. 25791.92.05, filed on Jul. 6, 2004, which was the National Stage patent application for PCT patent application PCT/US02/39418, filed on Dec. 10, 2002, attorney docket number 25791.92.02, the disclosures of which are incorporated herein by reference.

The present application is a continuation in part of PCT patent application serial no. PCT/US03/25716, filed on Aug. 18, 2003, attorney docket no. 25791.129.02, which was a continuation in part of PCT patent application serial no. PCT/US03/25707, filed on Aug. 18, 2003, attorney docket number 25791.127.02, which was a continuation in part of PCT patent application serial no. PCT/US03/25676, filed on Aug. 18, 2003, attorney docket number 25791.120.02, which was a continuation in part of PCT patent application serial no. PCT/US03/25677, filed on Aug. 18, 2003, attorney docket number 25791.119.02, which was a continuation in part of PCT patent application serial no. PCT/US03/19993, filed on Jun. 24, 2003, attorney docket number 25791.106.02, which was a continuation in part of PCT patent application serial no. PCT/US03/10144, filed on Mar. 31, 2003, attorney docket number 25791.101.02, which was a continuation in part of PCT patent application serial no. PCT/US03/06544, filed on Mar. 4, 2003, attorney docket number 25791.93.02, which was a continuation in part of PCT patent application PCT/US02/39418, filed on Dec. 10, 2002, attorney docket number 25791.92.02, the disclosures of which are incorporated herein by reference.

The present application is related to the following: (1) U.S. patent application Ser. No. 09/454,139, attorney docket no. 25791.03.02, filed on Dec. 3, 1999, (2) U.S. patent application Ser. No. 09/510,913, attorney docket no. 25791.7.02, filed on Feb. 23, 2000, (3) U.S. patent application Ser. No. 09/502,350, attorney docket no. 25791.8.02, filed on Feb. 10, 2000, (4) U.S. patent application Ser. No. 09/440,338, attorney docket no. 25791.9.02, filed on Nov. 15, 1999, (5) U.S. patent application Ser. No. 09/523,460, attorney docket no. 25791.11.02, filed on Mar. 10, 2000, (6) U.S. patent application Ser. No. 09/512,895, attorney docket no. 25791.12.02, filed on Feb. 24, 2000, (7) U.S. patent application Ser. No. 09/511,941, attorney docket no. 25791.16.02, filed on Feb. 24, 2000, (8) U.S. patent application Ser. No. 09/588,946, attorney docket no. 25791.17.02, filed on Jun. 7, 2000, (9) U.S. patent application Ser. No. 09/559,122, attorney docket no. 25791.23.02, filed on Apr. 26, 2000, (10) PCT patent application serial no. PCT/US00/18635, attorney docket no. 25791.25.02, filed on Jul. 9, 2000, (11) U.S. provisional patent application Ser. No. 60/162,671, attorney docket no. 25791.27, filed on Nov. 1, 1999, (12) U.S. provisional patent application Ser. No. 60/154,047, attorney docket no. 25791.29, filed on Sep. 16, 1999, (13) U.S. provisional patent application Ser. No. 60/159,082, attorney docket no. 25791.34, filed on Oct. 12, 1999, (14) U.S. provisional patent application Ser. No. 60/159,039, attorney docket no. 25791.36, filed on Oct. 12, 1999, (15) U.S. provisional patent application Ser. No. 60/159,033, attorney docket no. 25791.37, filed on Oct. 12, 1999, (16) U.S. provisional patent application Ser. No. 60/212,359, attorney docket no. 25791.38, filed on Jun. 19, 2000, (17) U.S. provisional patent application Ser. No. 60/165,228, attorney docket no. 25791.39, filed on Nov. 12, 1999, (18) U.S. provisional patent application Ser. No. 60/221,443, attorney docket no. 25791.45, filed on Jul. 28, 2000, (19) U.S. provisional patent application Ser. No. 60/221,645, attorney docket no. 25791.46, filed on Jul. 28, 2000, (20) U.S. provisional patent application Ser. No. 60/233,638, attorney docket no. 25791.47, filed on Sep. 18, 2000, (21) U.S. provisional patent application Ser. No. 60/237,334, attorney docket no. 25791.48, filed on Oct. 2, 2000, (22) U.S. provisional patent application Ser. No. 60/270,007, attorney docket no. 25791.50, filed on Feb. 20, 2001, (23) U.S. provisional patent application Ser. No. 60/262,434, attorney docket no. 25791.51, filed on Jan. 17, 2001, (24) U.S. provisional patent application Ser. No. 60/259,486, attorney docket no. 25791.52, filed on Jan. 3, 2001, (25) U.S. provisional patent application Ser. No. 60/303,740, attorney docket no. 25791.61, filed on Jul. 6, 2001, (26) U.S. provisional patent application Ser. No. 60/313,453, attorney docket no. 25791.59, filed on Aug. 20, 2001, (27) U.S. provisional patent application Ser. No. 60/317,985, attorney docket no. 25791.67, filed on Sep. 6, 2001, (28) U.S. provisional patent application Ser. No. 60/3318,386, attorney docket no. 25791.67.02, filed on Sep. 10, 2001, (29) U.S. utility patent application Ser. No. 09/969,922, attorney docket no. 25791.69, filed on Oct. 3, 2001, (30) U.S. utility patent application Ser. No. 10/016,467, attorney docket no. 25791.70, filed on Dec. 10, 2001, (31) U.S. provisional patent application Ser. No. 60/343,674, attorney docket no. 25791.68, filed on Dec. 27, 2001; and (32) U.S. provisional patent application Ser. No. 60/346,309, attorney docket no. 25791.92, filed on Jan. 7, 2002, (33) U.S. utility patent application Ser. No. ______, attorney docket number 25791.378, filed on Aug. 16, 2005, (34) U.S. utility patent application Ser. No. ______, attorney docket number 25791.379, filed on Aug. 16, 2005, (35) U.S. utility patent application Ser. No. ______, attorney docket number 25791.380, filed on Aug. 16, 2005, (36) U.S. utility patent application Ser. No. ______, attorney docket number 25791.381, filed on Aug. 16, 2005, (37) U.S. utility patent application Ser. No. ______, attorney docket number 25791.382, filed on Aug. 16, 2005, (38) U.S. utility patent application Ser. No. ______, attorney docket number 25791.185.05, filed on Aug. 16, 2005, the disclosures of which are incorporated herein by reference.

### BACKGROUND OF THE INVENTION

This invention relates generally to oil and gas exploration, and in particular to forming and repairing wellbore casings to facilitate oil and gas exploration.

During oil exploration, a wellbore typically traverses a number of zones within a subterranean formation. Wellbore casings are then formed in the wellbore by radially expanding and plastically deforming tubular members that are coupled to one another by threaded connections. Existing methods for radially expanding and plastically deforming tubular members coupled to one another by threaded connections are not always reliable or produce satisfactory results. In particular, the threaded connections can be damaged during the radial expansion process.

The present invention is directed to overcoming one or more of the limitations of the existing processes for radially expanding and plastically deforming tubular members coupled to one another by threaded connections.

### SUMMARY OF THE INVENTION

According to one aspect of the present invention, a radially expandable multiple tubular member apparatus is provided that includes a first tubular member; a second tubular member engaged with the first tubular member forming a joint; a sleeve overlapping and coupling the first and second tubular members at the joint; the sleeve having opposite tapered ends and a flange engaged in a recess formed in an adjacent tubular member; and one of the tapered ends being a surface formed on the flange.

According to another aspect of the present invention, a method of joining radially expandable multiple tubular members is provided that includes providing a first tubular member; engaging a second tubular member with the first tubular member to form a joint; providing a sleeve having opposite tapered ends and a flange, one of the tapered ends being a surface formed on the flange; and mounting the sleeve for overlapping and coupling the first and second tubular members at the joint, wherein the flange is engaged in a recess formed in an adjacent one of the tubular members.

According to another aspect of the present invention, a radially expandable multiple tubular member apparatus is provided that includes a first tubular member; a second tubular member engaged with the first tubular member forming a joint; and a sleeve overlapping and coupling the first and second tubular members at the joint; wherein at least a portion of the sleeve is comprised of a frangible material.

According to another aspect of the present invention, a radially expandable multiple tubular member apparatus is provided that includes a first tubular member, a second tubular member engaged with the first tubular member forming a joint, and a sleeve overlapping and coupling the first and second tubular members at the joint; wherein the wall thickness of the sleeve is variable.

According to another aspect of the present invention, a method of joining radially expandable multiple tubular members is provided that includes providing a first tubular member; engaging a second tubular member with the first tubular member to form a joint; providing a sleeve comprising a frangible material; and mounting the sleeve for overlapping and coupling the first and second tubular members at the joint.

According to another aspect of the present invention, a method of joining radially expandable multiple tubular members is provided that includes providing a first tubular member; engaging a second tubular member with the first tubular member to form a joint; providing a sleeve comprising a variable wall thickness; and mounting the sleeve for overlapping and coupling the first and second tubular members at the joint.

According to another aspect of the present invention, an expandable tubular assembly is provided that includes a first tubular member; a second tubular member coupled to the first tubular member; and means for increasing the axial compression loading capacity of the coupling between the first and second tubular members before and after a radial expansion and plastic deformation of the first and second tubular members.

According to another aspect of the present invention, an expandable tubular assembly is provided that includes a first tubular member; a second tubular member coupled to the first tubular member; and means for increasing the axial tension loading capacity of the coupling between the first and second tubular members before and after a radial expansion and plastic deformation of the first and second tubular members.

According to another aspect of the present invention, an expandable tubular assembly is provided that includes a first tubular member; a second tubular member coupled to the first tubular member; and means for increasing the axial compression and tension loading capacity of the coupling between the first and second tubular members before and after a radial expansion and plastic deformation of the first and second tubular members.

According to another aspect of the present invention, an expandable tubular assembly is provided that includes a first tubular member; a second tubular member coupled to the first tubular member; and means for avoiding stress risers in the coupling between the first and second tubular members before and after a radial expansion and plastic deformation of the first and second tubular members.

According to another aspect of the present invention, an expandable tubular assembly is provided that includes a first tubular member; a second tubular member coupled to the first tubular member; and means for inducing stresses at selected portions of the coupling between the first and second tubular members before and after a radial expansion and plastic deformation of the first and second tubular members.

According to another aspect of the present invention, an expandable tubular assembly is provided that includes a first tubular member, a second tubular member coupled to the first tubular member, a first threaded connection for coupling a portion of the first and second tubular members, a second threaded connection spaced apart from the first threaded connection for coupling another portion of the first and second tubular members, a tubular sleeve coupled to and receiving end portions of the first and second tubular members, and a sealing element positioned between the first and second spaced apart threaded connections for sealing an interface between the first and second tubular member, wherein the sealing element is positioned within an annulus defined between the first and second tubular members.

According to another aspect of the present invention, a method of joining radially expandable multiple tubular members is provided that includes providing a first tubular member, providing a second tubular member, providing a sleeve, mounting the sleeve for overlapping and coupling the first and second tubular members, threadably coupling the first and second tubular members at a first location, threadably coupling the first and second tubular members at a second location spaced apart from the first location, and sealing an interface between the first and second tubular members between the first and second locations using a compressible sealing element.

According to another aspect of the present invention, an expandable tubular assembly is provided that includes a first tubular member, a second tubular member coupled to the first tubular member, a first threaded connection for coupling a portion of the first and second tubular members, a second threaded connection spaced apart from the first threaded connection for coupling another portion of the first and second tubular members, and a plurality of spaced apart tubular sleeves coupled to and receiving end portions of the first and second tubular members.

According to another aspect of the present invention, a method of joining radially expandable multiple tubular members is provided that includes providing a first tubular member, providing a second tubular member, threadably coupling the first and second tubular members at a first location, threadably coupling the first and second tubular members at a second location spaced apart from the first location, providing a plurality of sleeves, and mounting the sleeves at spaced apart locations for overlapping and coupling the first and second tubular members.

According to another aspect of the present invention, an expandable tubular assembly is provided that includes a first tubular member, a second tubular member coupled to the first tubular member, and a plurality of spaced apart tubular sleeves coupled to and receiving end portions of the first and second tubular members.

According to another aspect of the present invention, a method of joining radially expandable multiple tubular members is provided that includes providing a first tubular member, providing a second tubular member, providing a plurality of sleeves, coupling the first and second tubular members, and mounting the sleeves at spaced apart locations for overlapping and coupling the first and second tubular members.

According to another aspect of the present invention, an expandable tubular assembly is provided that includes a first tubular member, a second tubular member coupled to the first tubular member, a threaded connection for coupling a portion of the first and second tubular members, and a tubular sleeves coupled to and receiving end portions of the first and second tubular members, wherein at least a portion of the threaded connection is upset.

According to another aspect of the present invention, a method of joining radially expandable multiple tubular members is provided that includes providing a first tubular member, providing a second tubular member, threadably coupling the first and second tubular members, and upsetting the threaded coupling.

According to another aspect of the present invention, a radially expandable multiple tubular member apparatus is provided that includes a first tubular member, a second tubular member engaged with the first tubular member forming a joint, a sleeve overlapping and coupling the first and second tubular members at the joint, and one or more stress concentrators for concentrating stresses in the joint.

According to another aspect of the present invention, a method of joining radially expandable multiple tubular members is provided that includes providing a first tubular member, engaging a second tubular member with the first tubular member to form a joint, providing a sleeve having opposite tapered ends and a flange, one of the tapered ends being a surface formed on the flange, and concentrating stresses within the joint.

According to another aspect of the present invention, a system for radially expanding and plastically deforming a first tubular member coupled to a second tubular member by a mechanical connection is provided that includes means for radially expanding the first and second tubular members, and means for maintaining portions of the first and second tubular member in circumferential compression following the radial expansion and plastic deformation of the first and second tubular members.

According to another aspect of the present invention, a system for radially expanding and plastically deforming a first tubular member coupled to a second tubular member by a mechanical connection is provided that includes means for radially expanding the first and second tubular members; and means for concentrating stresses within the mechanical connection during the radial expansion and plastic deformation of the first and second tubular members.

According to another aspect of the present invention, a system for radially expanding and plastically deforming a first tubular member coupled to a second tubular member by a mechanical connection is provided that includes means for radially expanding the first and second tubular members; means for maintaining portions of the first and second tubular member in circumferential compression following the radial expansion and plastic deformation of the first and second tubular members; and means for concentrating stresses within the mechanical connection during the radial expansion and plastic deformation of the first and second tubular members.

### BRIEF DESCRIPTION OF THE DRAWINGS

FIG. 1 is a fragmentary cross-sectional view illustrating an embodiment of the radial expansion and plastic deformation of a portion of a first tubular member having an internally threaded connection at an end portion, an embodiment of a tubular sleeve supported by the end portion of the first tubular member, and a second tubular member having an externally threaded portion coupled to the internally threaded portion of the first tubular member and engaged by a flange of the sleeve. The sleeve includes the flange at one end for increasing axial compression loading.

FIG. 2 is a fragmentary cross-sectional view illustrating an embodiment of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes flanges at opposite ends for increasing axial tension loading.

FIG. 3 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes flanges at opposite ends for increasing axial compression/tension loading.

FIG. 4 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes flanges at opposite ends having sacrificial material thereon.

FIG. 5 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes a thin walled cylinder of sacrificial material.

FIG. 6 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes a variable thickness along the length thereof.

FIG. 7 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes a member coiled onto grooves formed in the sleeve for varying the sleeve thickness.

FIG. 8 is a fragmentary cross-sectional illustration of an exemplary embodiment of an expandable connection.

FIGS. 9a-9c are fragmentary cross-sectional illustrations of exemplary embodiments of expandable connections.

FIG. 10 is a fragmentary cross-sectional illustration of an exemplary embodiment of an expandable connection.

FIGS. 11a and 11b are fragmentary cross-sectional illustrations of the formation of an exemplary embodiment of an expandable connection.

FIG. 12 is a fragmentary cross-sectional illustration of an exemplary embodiment of an expandable connection.

FIGS. 13a, 13b and 13c are fragmentary cross-sectional illustrations of an exemplary embodiment of an expandable connection.

### DETAILED DESCRIPTION OF THE ILLUSTRATIVE EMBODIMENTS

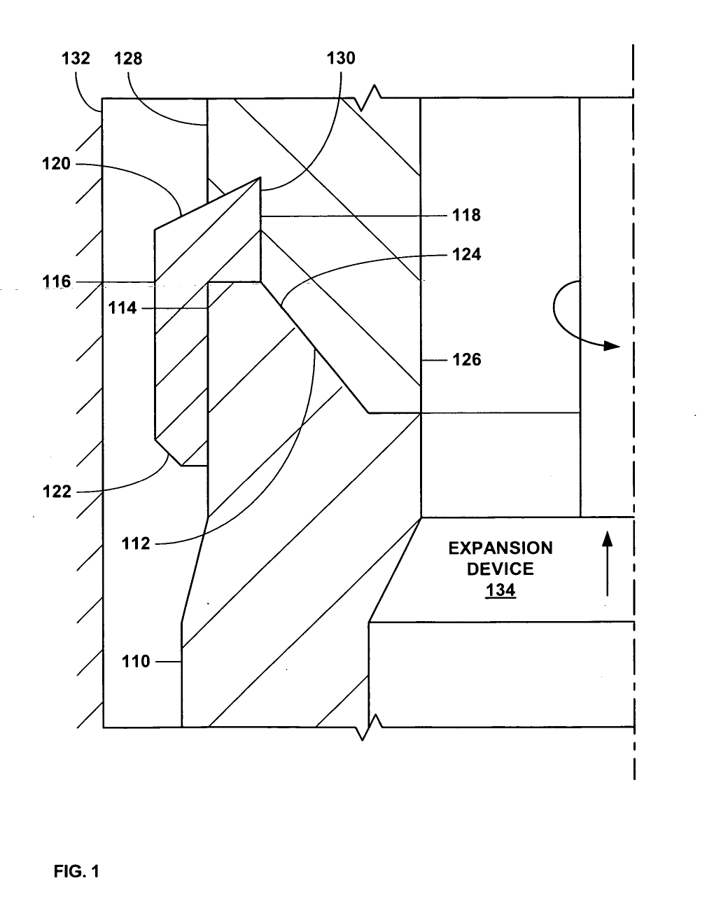

Referring to FIG. 1 in an exemplary embodiment, a first tubular member 110 includes an internally threaded connection 112 at an end portion 114. A first end of a tubular sleeve 116 that includes an internal flange 118 having a tapered portion 120, and a second end that includes a tapered portion 122, is then mounted upon and receives the end portion 114 of the first tubular member 110. In an exemplary embodiment, the end portion 114 of the first tubular member 110 abuts one side of the internal flange 118 of the tubular sleeve 116, and the internal diameter of the internal flange 118 of the tubular sleeve 116 is substantially equal to or greater than the maximum internal diameter of the internally threaded connection 112 of the end portion 114 of the first tubular member 110. An externally threaded connection 124 of an end portion 126 of a second tubular member 128 having an annular recess 130 is then positioned within the tubular sleeve 116 and threadably coupled to the internally threaded connection 112 of the end portion 114 of the first tubular member 110. In an exemplary embodiment, the internal flange 118 of the tubular sleeve 116 mates with and is received within the annular recess 130 of the end portion 126 of the second tubular member 128. Thus, the tubular sleeve 116 is coupled to and surrounds the external surfaces of the first and second tubular members, 110 and 128.

The internally threaded connection 112 of the end portion 114 of the first tubular member 110 is a box connection, and the externally threaded connection 124 of the end portion 126 of the second tubular member 128 is a pin connection. In an exemplary embodiment, the internal diameter of the tubular sleeve 116 is at least approximately 0.020″ greater than the outside diameters of the first and second tubular members, 110 and 128. In this manner, during the threaded coupling of the first and second tubular members, 110 and 128, fluidic materials within the first and second tubular members may be vented from the tubular members.

As illustrated in FIG. 1, the first and second tubular members, 110 and 128, and the tubular sleeve 116 may be positioned within another structure 132 such as, for example, a cased or uncased wellbore, and radially expanded and plastically deformed, for example, by displacing and/or rotating a conventional expansion device 134 within and/or through the interiors of the first and second tubular members. The tapered portions, 120 and 122, of the tubular sleeve 116 facilitate the insertion and movement of the first and second tubular members within and through the structure 132, and the movement of the expansion device 134 through the interiors of the first and second tubular members, 110 and 128, may be from top to bottom or from bottom to top.

During the radial expansion and plastic deformation of the first and second tubular members, 110 and 128, the tubular sleeve 116 is also radially expanded and plastically deformed. As a result, the tubular sleeve 116 may be maintained in circumferential tension and the end portions, 114 and 126, of the first and second tubular members, 110 and 128, may be maintained in circumferential compression.

Sleeve 116 increases the axial compression loading of the connection between tubular members 110 and 128 before and after expansion by the expansion device 134. Sleeve 116 may be secured to tubular members 110 and 128 by a heat shrink fit.

In several alternative embodiments, the first and second tubular members, 110 and 128, are radially expanded and plastically deformed using other conventional methods for radially expanding and plastically deforming tubular members such as, for example, internal pressurization, hydroforming, and/or roller expansion devices and/or any one or combination of the conventional commercially available expansion products and services available from Baker Hughes, Weatherford International, and/or Enventure Global Technology L.L.C.

The use of the tubular sleeve 116 during (a) the coupling of the first tubular member 110 to the second tubular member 128, (b) the placement of the first and second tubular members in the structure 132, and (c) the radial expansion and plastic deformation of the first and second tubular members provides a number of significant benefits. For example, the tubular sleeve 116 protects the exterior surfaces of the end portions, 114 and 126, of the first and second tubular members, 110 and 128, during handling and insertion of the tubular members within the structure 132. In this manner, damage to the exterior surfaces of the end portions, 114 and 126, of the first and second tubular members, 110 and 128, is avoided that could otherwise result in stress concentrations that could cause a catastrophic failure during subsequent radial expansion operations. Furthermore, the tubular sleeve 116 provides an alignment guide that facilitates the insertion and threaded coupling of the second tubular member 128 to the first tubular member 110. In this manner, misalignment that could result in damage to the threaded connections, 112 and 124, of the first and second tubular members, 110 and 128, may be avoided. In addition, during the relative rotation of the second tubular member with respect to the first tubular member, required during the threaded coupling of the first and second tubular members, the tubular sleeve 116 provides an indication of to what degree the first and second tubular members are threadably coupled. For example, if the tubular sleeve 116 can be easily rotated, that would indicate that the first and second tubular members, 110 and 128, are not fully threadably coupled and in intimate contact with the internal flange 118 of the tubular sleeve. Furthermore, the tubular sleeve 116 may prevent crack propagation during the radial expansion and plastic deformation of the first and second tubular members, 110 and 128. In this manner, failure modes such as, for example, longitudinal cracks in the end portions, 114 and 126, of the first and second tubular members may be limited in severity or eliminated all together. In addition, after completing the radial expansion and plastic deformation of the first and second tubular members, 110 and 128, the tubular sleeve 116 may provide a fluid tight metal-to-metal seal between interior surface of the tubular sleeve 116 and the exterior surfaces of the end portions, 114 and 126, of the first and second tubular members. In this manner, fluidic materials are prevented from passing through the threaded connections, 112 and 124, of the first and second tubular members, 110 and 128, into the annulus between the first and second tubular members and the structure 132. Furthermore, because, following the radial expansion and plastic deformation of the first and second tubular members, 110 and 128, the tubular sleeve 116 may be maintained in circumferential tension and the end portions, 114 and 126, of the first and second tubular members, 110 and 128, may be maintained in circumferential compression, axial loads and/or torque loads may be transmitted through the tubular sleeve.

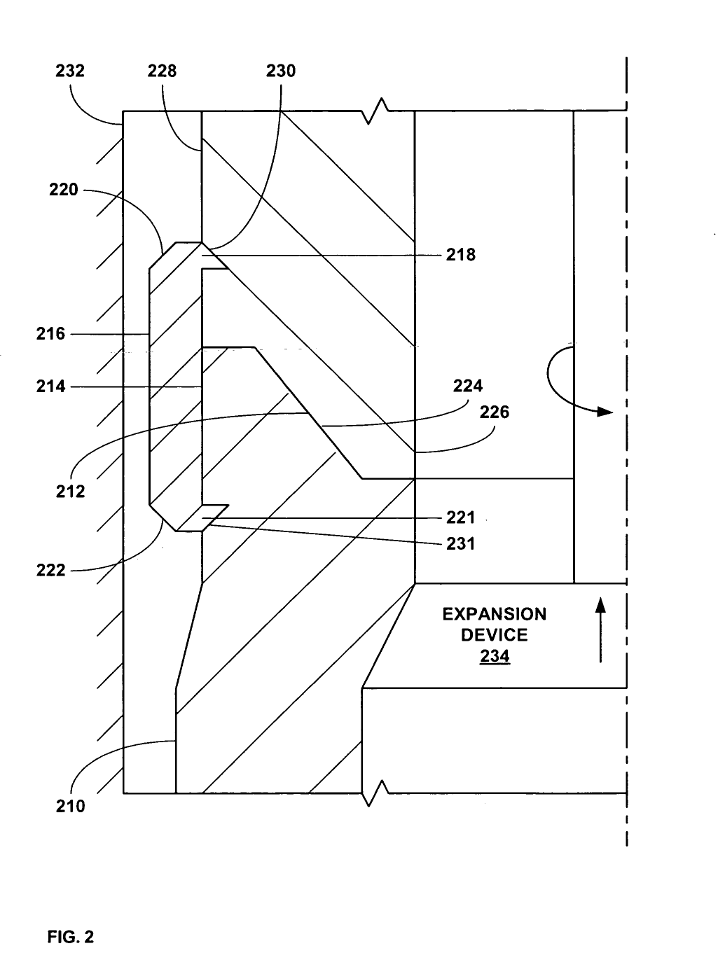

Referring to FIG. 2, in an exemplary embodiment, a first tubular member 210 includes an internally threaded connection 212 at an end portion 214. A first end of a tubular sleeve 216 includes an internal flange 218 and a tapered portion 220. A second end of the sleeve 216 includes an internal flange 221 and a tapered portion 222. An externally threaded connection 224 of an end portion 226 of a second tubular member 228 having an annular recess 230, is then positioned within the tubular sleeve 216 and threadably coupled to the internally threaded connection 212 of the end portion 214 of the first tubular member 210. The internal flange 218 of the sleeve 216 mates with and is received within the annular recess 230.

The first tubular member 210 includes a recess 231. The internal flange 221 mates with and is received within the annular recess 231. Thus, the sleeve 216 is coupled to and surrounds the external surfaces of the first and second tubular members 210 and 228.

The internally threaded connection 212 of the end portion 214 of the first tubular member 210 is a box connection, and the externally threaded connection 224 of the end portion 226 of the second tubular member 228 is a pin connection. In an exemplary embodiment, the internal diameter of the tubular sleeve 216 is at least approximately 0.020″ greater than the outside diameters of the first and second tubular members 210 and 228. In this manner, during the threaded coupling of the first and second tubular members 210 and 228, fluidic materials within the first and second tubular members may be vented from the tubular members.

As illustrated in FIG. 2, the first and second tubular members 210 and 228, and the tubular sleeve 216 may then be positioned within another structure 232 such as, for example, a wellbore, and radially expanded and plastically deformed, for example, by displacing and/or rotating an expansion device 234 through and/or within the interiors of the first and second tubular members. The tapered portions 220 and 222, of the tubular sleeve 216 facilitates the insertion and movement of the first and second tubular members within and through the structure 232, and the displacement of the expansion device 234 through the interiors of the first and second tubular members 210 and 228, may be from top to bottom or from bottom to top.

During the radial expansion and plastic deformation of the first and second tubular members 210 and 228, the tubular sleeve 216 is also radially expanded and plastically deformed. In an exemplary embodiment, as a result, the tubular sleeve 216 may be maintained in circumferential tension and the end portions 214 and 226, of the first and second tubular members 210 and 228, may be maintained in circumferential compression.

Sleeve 216 increases the axial tension loading of the connection between tubular members 210 and 228 before and after expansion by the expansion device 234. Sleeve 216 may be secured to tubular members 210 and 228 by a heat shrink fit.

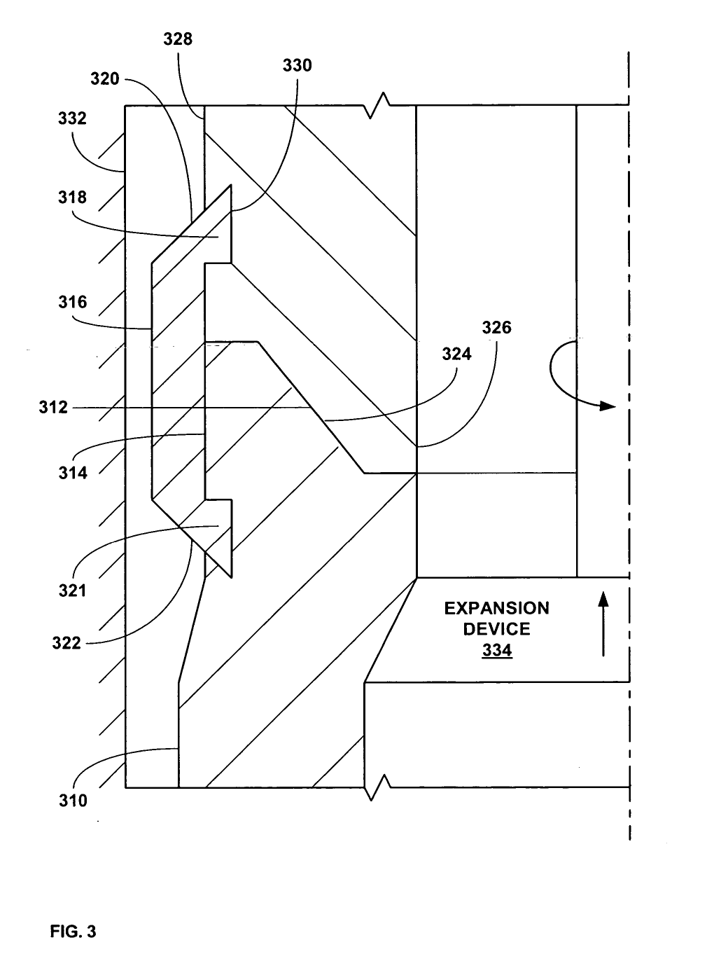

Referring to FIG. 3, in an exemplary embodiment, a first tubular member 310 includes an internally threaded connection 312 at an end portion 314. A first end of a tubular sleeve 316 includes an internal flange 318 and a tapered portion 320. A second end of the sleeve 316 includes an internal flange 321 and a tapered portion 322. An externally threaded connection 324 of an end portion 326 of a second tubular member 328 having an annular recess 330, is then positioned within the tubular sleeve 316 and threadably coupled to the internally threaded connection 312 of the end portion 314 of the first tubular member 310. The internal flange 318 of the sleeve 316 mates with and is received within the annular recess 330. The first tubular member 310 includes a recess 331. The internal flange 321 mates with and is received within the annular recess 331. Thus, the sleeve 316 is coupled to and surrounds the external surfaces of the first and second tubular members 310 and 328.

The internally threaded connection 312 of the end portion 314 of the first tubular member 310 is a box connection, and the externally threaded connection 324 of the end portion 326 of the second tubular member 328 is a pin connection. In an exemplary embodiment, the internal diameter of the tubular sleeve 316 is at least approximately 0.020″ greater than the outside diameters of the first and second tubular members 310 and 328. In this manner, during the threaded coupling of the first and second tubular members 310 and 328, fluidic materials within the first and second tubular members may be vented from the tubular members.

As illustrated in FIG. 3, the first and second tubular members 310 and 328, and the tubular sleeve 316 may then be positioned within another structure 332 such as, for example, a wellbore, and radially expanded and plastically deformed, for example, by displacing and/or rotating an expansion device 334 through and/or within the interiors of the first and second tubular members. The tapered portions 320 and 322, of the tubular sleeve 316 facilitate the insertion and movement of the first and second tubular members within and through the structure 332, and the displacement of the expansion device 334 through the interiors of the first and second tubular members, 310 and 328, may be from top to bottom or from bottom to top.

During the radial expansion and plastic deformation of the first and second tubular members, 310 and 328, the tubular sleeve 316 is also radially expanded and plastically deformed. In an exemplary embodiment, as a result, the tubular sleeve 316 may be maintained in circumferential tension and the end portions, 314 and 326, of the first and second tubular members, 310 and 328, may be maintained in circumferential compression.

The sleeve 316 increases the axial compression and tension loading of the connection between tubular members 310 and 328 before and after expansion by expansion device 324. Sleeve 316 may be secured to tubular members 310 and 328 by a heat shrink fit.

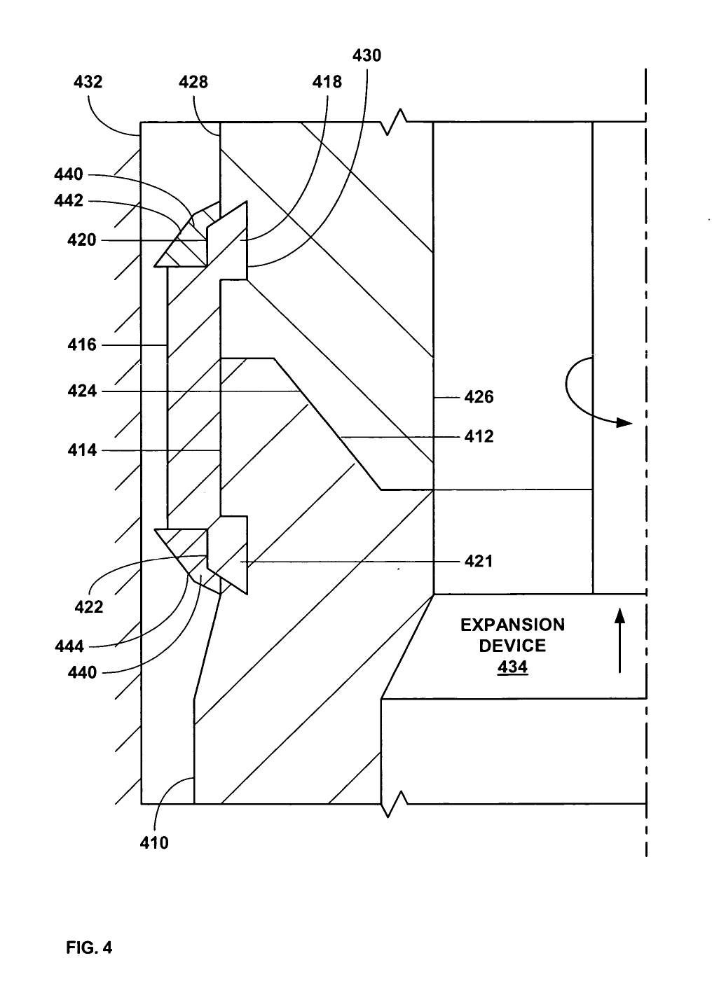

Referring to FIG. 4, in an exemplary embodiment, a first tubular member 410 includes an internally threaded connection 412 at an end portion 414. A first end of a tubular sleeve 416 includes an internal flange 418 and a relief 420. A second end of the sleeve 416 includes an internal flange 421 and a relief 422. An externally threaded connection 424 of an end portion 426 of a second tubular member 428 having an annular recess 430, is then positioned within the tubular sleeve 416 and threadably coupled to the internally threaded connection 412 of the end portion 414 of the first tubular member 410. The internal flange 418 of the sleeve 416 mates with and is received within the annular recess 430. The first tubular member 410 includes a recess 431. The internal flange 421 mates with and is received within the annular recess 431. Thus, the sleeve 416 is coupled to and surrounds the external surfaces of the first and second tubular members 410 and 428.

The internally threaded connection 412 of the end portion 414 of the first tubular member 410 is a box connection, and the externally threaded connection 424 of the end portion 426 of the second tubular member 428 is a pin connection. In an exemplary embodiment, the internal diameter of the tubular sleeve 416 is at least approximately 0.020″ greater than the outside diameters of the first and second tubular members 410 and 428. In this manner, during the threaded coupling of the first and second tubular members 410 and 428, fluidic materials within the first and second tubular members may be vented from the tubular members.

As illustrated in FIG. 4, the first and second tubular members 410 and 428, and the tubular sleeve 416 may then be positioned within another structure 432 such as, for example, a wellbore, and radially expanded and plastically deformed, for example, by displacing and/or rotating an expansion device 434 through and/or within the interiors of the first and second tubular members. The reliefs 420 and 422 are each filled with a sacrificial material 440 including a tapered surface 442 and 444, respectively. The material 440 may be a metal or a synthetic, and is provided to facilitate the insertion and movement of the first and second tubular members 410 and 428, through the structure 432. The displacement of the expansion device 434 through the interiors of the first and second tubular members 410 and 428, may be from top to bottom or from bottom to top.

During the radial expansion and plastic deformation of the first and second tubular members 410 and 428, the tubular sleeve 416 is also radially expanded and plastically deformed. In an exemplary embodiment, as a result, the tubular sleeve 416 may be maintained in circumferential tension and the end portions 414 and 426, of the first and second tubular members, 410 and 428, may be maintained in circumferential compression.

The addition of the sacrificial material 440, provided on sleeve 416, avoids stress risers on the sleeve 416 and the tubular member 410. The tapered surfaces 442 and 444 are intended to wear or even become damaged, thus incurring such wear or damage which would otherwise be borne by sleeve 416. Sleeve 416 may be secured to tubular members 410 and 428 by a heat shrink fit.

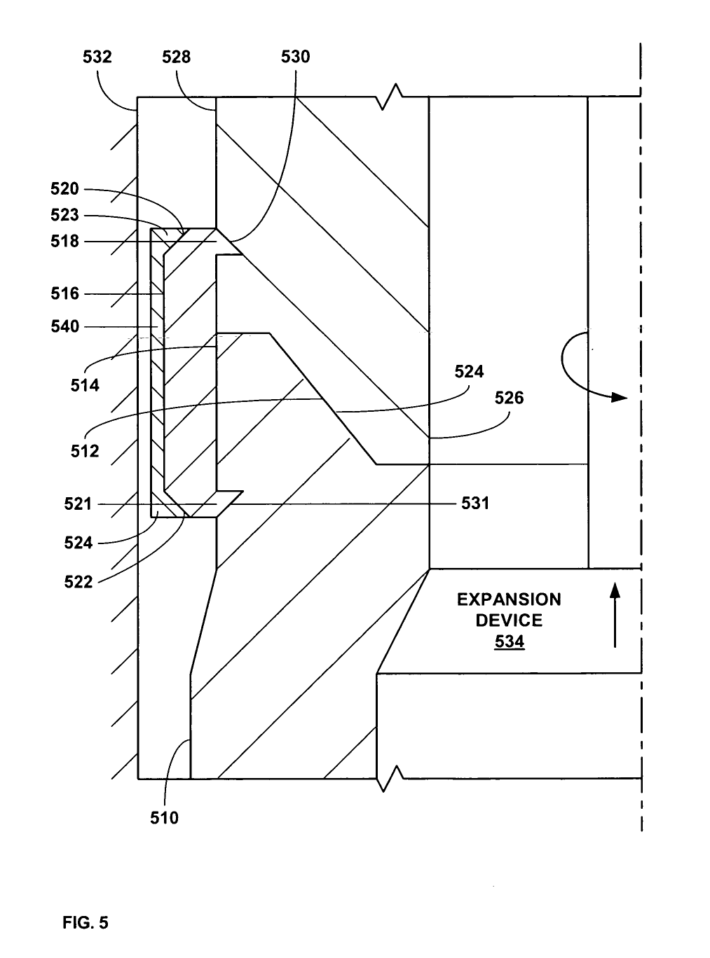

Referring to FIG. 5, in an exemplary embodiment, a first tubular member 510 includes an internally threaded connection 512 at an end portion 514. A first end of a tubular sleeve 516 includes an internal flange 518 and a tapered portion 520. A second end of the sleeve 516 includes an internal flange 521 and a tapered portion 522. An externally threaded connection 524 of an end portion 526 of a second tubular member 528 having an annular recess 530, is then positioned within the tubular sleeve 516 and threadably coupled to the internally threaded connection 512 of the end portion 514 of the first tubular member 510. The internal flange 518 of the sleeve 516 mates with and is received within the annular recess 530.

The first tubular member 510 includes a recess 531. The internal flange 521 mates with and is received within the annular recess 531. Thus, the sleeve 516 is coupled to and surrounds the external surfaces of the first and second tubular members 510 and 528.

The internally threaded connection 512 of the end portion 514 of the first tubular member 510 is a box connection, and the externally threaded connection 524 of the end portion 526 of the second tubular member 528 is a pin connection. In an exemplary embodiment, the internal diameter of the tubular sleeve 516 is at least approximately 0.020″ greater than the outside diameters of the first and second tubular members 510 and 528. In this manner, during the threaded coupling of the first and second tubular members 510 and 528, fluidic materials within the first and second tubular members may be vented from the tubular members.

As illustrated in FIG. 5, the first and second tubular members 510 and 528, and the tubular sleeve 516 may then be positioned within another structure 532 such as, for example, a wellbore, and radially expanded and plastically deformed, for example, by displacing and/or rotating an expansion device 534 through and/or within the interiors of the first and second tubular members. The tapered portions 520 and 522, of the tubular sleeve 516 facilitates the insertion and movement of the first and second tubular members within and through the structure 532, and the displacement of the expansion device 534 through the interiors of the first and second tubular members 510 and 528, may be from top to bottom or from bottom to top.

During the radial expansion and plastic deformation of the first and second tubular members 510 and 528, the tubular sleeve 516 is also radially expanded and plastically deformed. In an exemplary embodiment, as a result, the tubular sleeve 516 may be maintained in circumferential tension and the end portions 514 and 526, of the first and second tubular members 510 and 528, may be maintained in circumferential compression.

Sleeve 516 is covered by a thin walled cylinder of sacrificial material 540. Spaces 523 and 524, adjacent tapered portions 520 and 522, respectively, are also filled with an excess of the sacrificial material 540. The material may be a metal or a synthetic, and is provided to facilitate the insertion and movement of the first and second tubular members 510 and 528, through the structure 532.

The addition of the sacrificial material 540, provided on sleeve 516, avoids stress risers on the sleeve 516 and the tubular member 510. The excess of the sacrificial material 540 adjacent tapered portions 520 and 522 are intended to wear or even become damaged, thus incurring such wear or damage which would otherwise be borne by sleeve 516. Sleeve 516 may be secured to tubular members 510 and 528 by a heat shrink fit.

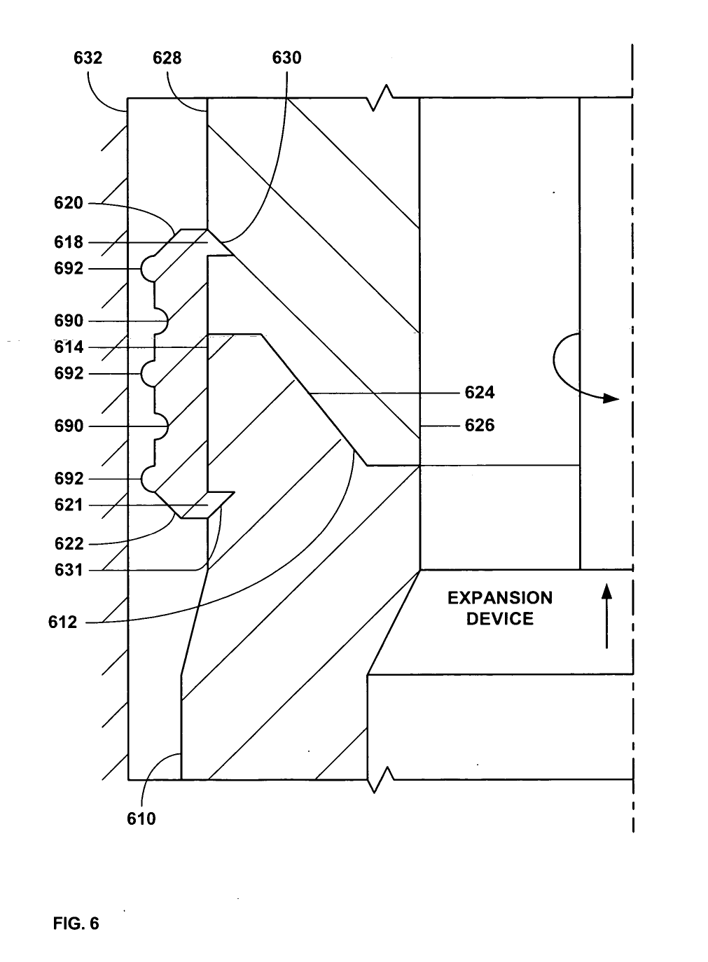

Referring to FIG. 6, in an exemplary embodiment, a first tubular member 610 includes an internally threaded connection 612 at an end portion 614. A first end of a tubular sleeve 616 includes an internal flange 618 and a tapered portion 620. A second end of the sleeve 616 includes an internal flange 621 and a tapered portion 622. An externally threaded connection 624 of an end portion 626 of a second tubular member 628 having an annular recess 630, is then positioned within the tubular sleeve 616 and threadably coupled to the internally threaded connection 612 of the end portion 614 of the first tubular member 610. The internal flange 618 of the sleeve 616 mates with and is received within the annular recess 630.

The first tubular member 610 includes a recess 631. The internal flange 621 mates with and is received within the annular recess 631. Thus, the sleeve 616 is coupled to and surrounds the external surfaces of the first and second tubular members 610 and 628.

The internally threaded connection 612 of the end portion 614 of the first tubular member 610 is a box connection, and the externally threaded connection 624 of the end portion 626 of the second tubular member 628 is a pin connection. In an exemplary embodiment, the internal diameter of the tubular sleeve 616 is at least approximately 0.020″ greater than the outside diameters of the first and second tubular members 610 and 628. In this manner, during the threaded coupling of the first and second tubular members 610 and 628, fluidic materials within the first and second tubular members may be vented from the tubular members.

As illustrated in FIG. 6, the first and second tubular members 610 and 628, and the tubular sleeve 616 may then be positioned within another structure 632 such as, for example, a wellbore, and radially expanded and plastically deformed, for example, by displacing and/or rotating an expansion device 634 through and/or within the interiors of the first and second tubular members. The tapered portions 620 and 622, of the tubular sleeve 616 facilitates the insertion and movement of the first and second tubular members within and through the structure 632, and the displacement of the expansion device 634 through the interiors of the first and second tubular members 610 and 628, may be from top to bottom or from bottom to top.

During the radial expansion and plastic deformation of the first and second tubular members 610 and 628, the tubular sleeve 616 is also radially expanded and plastically deformed. In an exemplary embodiment, as a result, the tubular sleeve 616 may be maintained in circumferential tension and the end portions 614 and 626, of the first and second tubular members 610 and 628, may be maintained in circumferential compression.

Sleeve 616 has a variable thickness due to one or more reduced thickness portions 690 and/or increased thickness portions 692.

Varying the thickness of sleeve 616 provides the ability to control or induce stresses at selected positions along the length of sleeve 616 and the end portions 624 and 626. Sleeve 616 may be secured to tubular members 610 and 628 by a heat shrink fit.

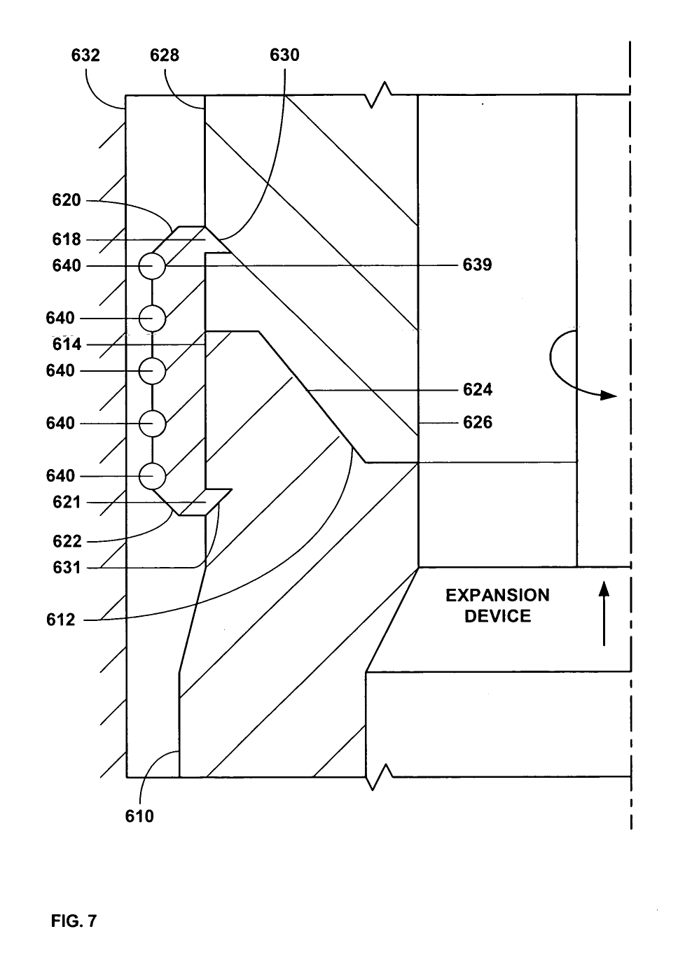

Referring to FIG. 7, in an alternative embodiment, instead of varying the thickness of sleeve 616, the same result described above with reference to FIG. 6, may be achieved by adding a member 640 which may be coiled onto the grooves 639 formed in sleeve 616, thus varying the thickness along the length of sleeve 616.

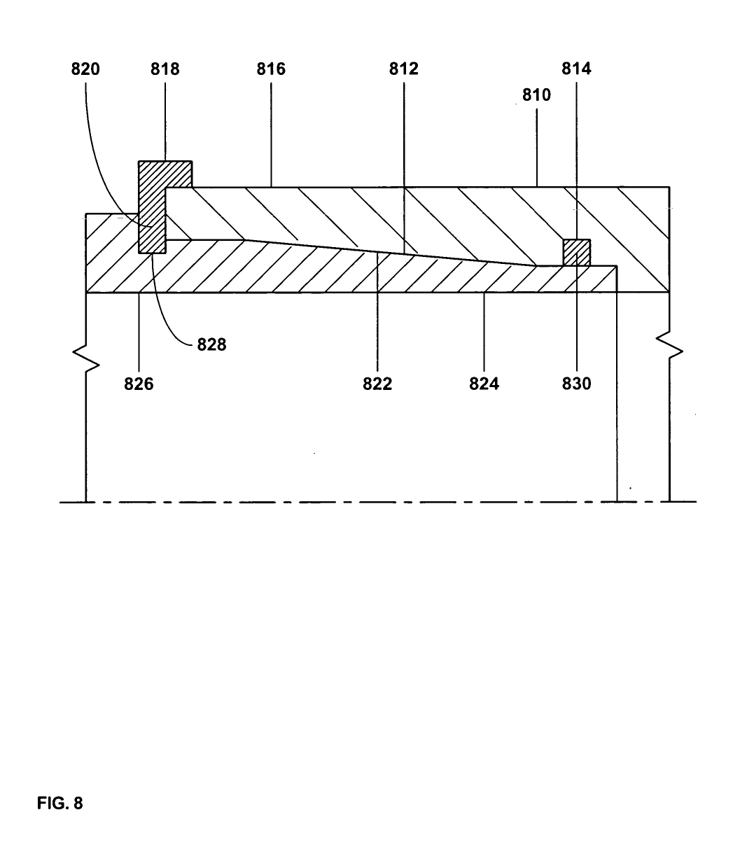

Referring to FIG. 8, in an exemplary embodiment, a first tubular member 810 includes an internally threaded connection 812 and an internal annular recess 814 at an end portion 816. A first end of a tubular sleeve 818 includes an internal flange 820, and a second end of the sleeve 816 mates with and receives the end portion 816 of the first tubular member 810. An externally threaded connection 822 of an end portion 824 of a second tubular member 826 having an annular recess 828, is then positioned within the tubular sleeve 818 and threadably coupled to the internally threaded connection 812 of the end portion 816 of the first tubular member 810. The internal flange 820 of the sleeve 818 mates with and is received within the annular recess 828. A sealing element 830 is received within the internal annular recess 814 of the end portion 816 of the first tubular member 810.

The internally threaded connection 812 of the end portion 816 of the first tubular member 810 is a box connection, and the externally threaded connection 822 of the end portion 824 of the second tubular member 826 is a pin connection. In an exemplary embodiment, the internal diameter of the tubular sleeve 818 is at least approximately 0.020″ greater than the outside diameters of the first tubular member 810. In this manner, during the threaded coupling of the first and second tubular members 810 and 826, fluidic materials within the first and second tubular members may be vented from the tubular members.

The first and second tubular members 810 and 826, and the tubular sleeve 818 may be positioned within another structure such as, for example, a wellbore, and radially expanded and plastically deformed, for example, by displacing and/or rotating an expansion device through and/or within the interiors of the first and second tubular members.

During the radial expansion and plastic deformation of the first and second tubular members 810 and 826, the tubular sleeve 818 is also radially expanded and plastically deformed. In an exemplary embodiment, as a result, the tubular sleeve 818 may be maintained in circumferential tension and the end portions 816 and 824, of the first and second tubular members 810 and 826, respectively, may be maintained in circumferential compression.

In an exemplary embodiment, before, during, and after the radial expansion and plastic deformation of the first and second tubular members 810 and 826, and the tubular sleeve 818, the sealing element 830 seals the interface between the first and second tubular members. In an exemplary embodiment, during and after the radial expansion and plastic deformation of the first and second tubular members 810 and 826, and the tubular sleeve 818, a metal to metal seal is formed between at least one of: the first and second tubular members 810 and 826, the first tubular member and the tubular sleeve 818, and/or the second tubular member and the tubular sleeve. In an exemplary embodiment, the metal to metal seal is both fluid tight and gas tight.

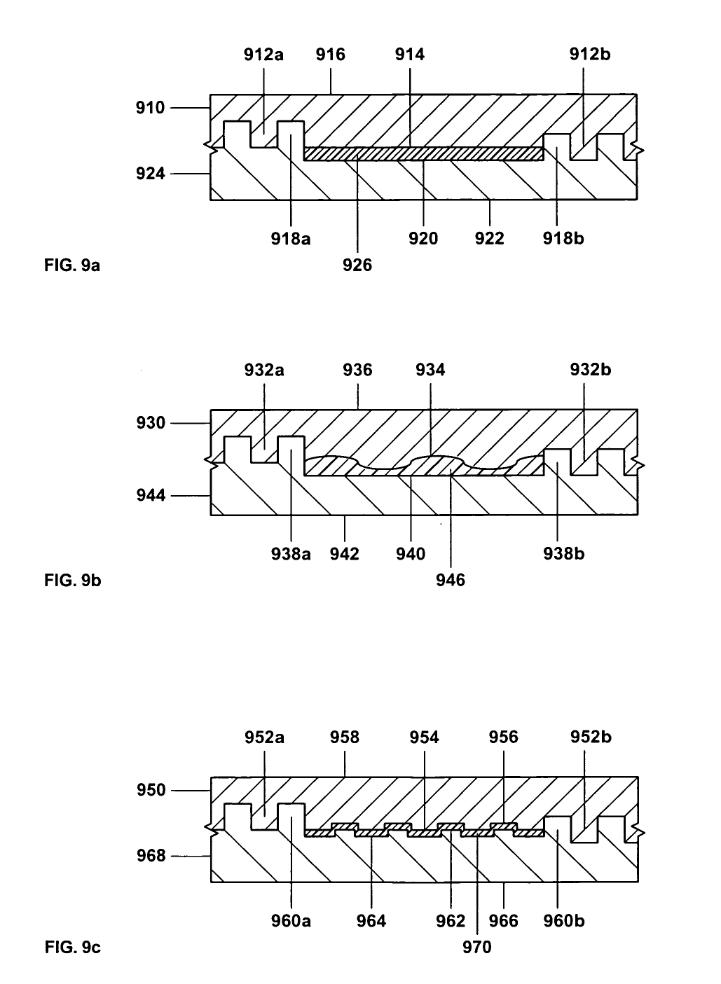

Referring to FIG. 9a, in an exemplary embodiment, a first tubular member 910 includes internally threaded connections 912a and 912b, spaced apart by a cylindrical internal surface 914, at an end portion 916. Externally threaded connections 918a and 918b, spaced apart by a cylindrical external surface 920, of an end portion 922 of a second tubular member 924 are threadably coupled to the internally threaded connections, 912a and 912b, respectively, of the end portion 916 of the first tubular member 910. A sealing element 926 is received within an annulus defined between the internal cylindrical surface 914 of the first tubular member 910 and the external cylindrical surface 920 of the second tubular member 924.

The internally threaded connections, 912a and 912b, of the end portion 916 of the first tubular member 910 are box connections, and the externally threaded connections, 918a and 918b, of the end portion 922 of the second tubular member 924 are pin connections. In an exemplary embodiment, the sealing element 926 is an elastomeric and/or metallic sealing element.

The first and second tubular members 910 and 924 may be positioned within another structure such as, for example, a wellbore, and radially expanded and plastically deformed, for example, by displacing and/or rotating an expansion device through and/or within the interiors of the first and second tubular members.

In an exemplary embodiment, before, during, and after the radial expansion and plastic deformation of the first and second tubular members 910 and 924, the sealing element 926 seals the interface between the first and second tubular members. In an exemplary embodiment, before, during and/or after the radial expansion and plastic deformation of the first and second tubular members 910 and 924, a metal to metal seal is formed between at least one of: the first and second tubular members 910 and 924, the first tubular member and the sealing element 926, and/or the second tubular member and the sealing element. In an exemplary embodiment, the metal to metal seal is both fluid tight and gas tight.

In an alternative embodiment, the sealing element 926 is omitted, and during and/or after the radial expansion and plastic deformation of the first and second tubular members 910 and 924, a metal to metal seal is formed between the first and second tubular members.

Referring to FIG. 9b, in an exemplary embodiment, a first tubular member 930 includes internally threaded connections 932a and 932b, spaced apart by an undulating approximately cylindrical internal surface 934, at an end portion 936. Externally threaded connections 938a and 938b, spaced apart by a cylindrical external surface 940, of an end portion 942 of a second tubular member 944 are threadably coupled to the internally threaded connections, 932a and 932b, respectively, of the end portion 936 of the first tubular member 930. A sealing element 946 is received within an annulus defined between the undulating approximately cylindrical internal surface 934 of the first tubular member 930 and the external cylindrical surface 940 of the second tubular member 944.

The internally threaded connections, 932a and 932b, of the end portion 936 of the first tubular member 930 are box connections, and the externally threaded connections, 938a and 938b, of the end portion 942 of the second tubular member 944 are pin connections. In an exemplary embodiment, the sealing element 946 is an elastomeric and/or metallic sealing element.

The first and second tubular members 930 and 944 may be positioned within another structure such as, for example, a wellbore, and radially expanded and plastically deformed, for example, by displacing and/or rotating an expansion device through and/or within the interiors of the first and second tubular members.

In an exemplary embodiment, before, during, and after the radial expansion and plastic deformation of the first and second tubular members 930 and 944, the sealing element 946 seals the interface between the first and second tubular members. In an exemplary embodiment, before, during and/or after the radial expansion and plastic deformation of the first and second tubular members 930 and 944, a metal to metal seal is formed between at least one of: the first and second tubular members 930 and 944, the first tubular member and the sealing element 946, and/or the second tubular member and the sealing element. In an exemplary embodiment, the metal to metal seal is both fluid tight and gas tight.

In an alternative embodiment, the sealing element 946 is omitted, and during and/or after the radial expansion and plastic deformation of the first and second tubular members 930 and 944, a metal to metal seal is formed between the first and second tubular members.

Referring to FIG. 9c, in an exemplary embodiment, a first tubular member 950 includes internally threaded connections 952a and 952b, spaced apart by a cylindrical internal surface 954 including one or more square grooves 956, at an end portion 958. Externally threaded connections 960a and 960b, spaced apart by a cylindrical external surface 962 including one or more square grooves 964, of an end portion 966 of a second tubular member 96 & are threadably coupled to the internally threaded connections, 952a and 952b, respectively, of the end portion 958 of the first tubular member 950. A sealing element 970 is received within an annulus defined between the cylindrical internal surface 954 of the first tubular member 950 and the external cylindrical surface 962 of the second tubular member 968.

The internally threaded connections, 952a and 952b, of the end portion 958 of the first tubular member 950 are box connections, and the externally threaded connections, 960a and 960b, of the end portion 966 of the second tubular member 968 are pin connections. In an exemplary embodiment, the sealing element 970 is an elastomeric and/or metallic sealing element.

The first and second tubular members 950 and 968 may be positioned within another structure such as, for example, a wellbore, and radially expanded and plastically deformed, for example, by displacing and/or rotating an expansion device through and/or within the interiors of the first and second tubular members.

In an exemplary embodiment, before, during, and after the radial expansion and plastic deformation of the first and second tubular members 950 and 968, the sealing element 970 seals the interface between the first and second tubular members. In an exemplary embodiment, before, during and/or after the radial expansion and plastic deformation of the first and second tubular members, 950 and 968, a metal to metal seal is formed between at least one of: the first and second tubular members, the first tubular member and the sealing element 970, and/or the second tubular member and the sealing element. In an exemplary embodiment, the metal to metal seal is both fluid tight and gas tight.

In an alternative embodiment, the sealing element 970 is omitted, and during and/or after the radial expansion and plastic deformation of the first and second tubular members 950 and 968, a metal to metal seal is formed between the first and second tubular members.

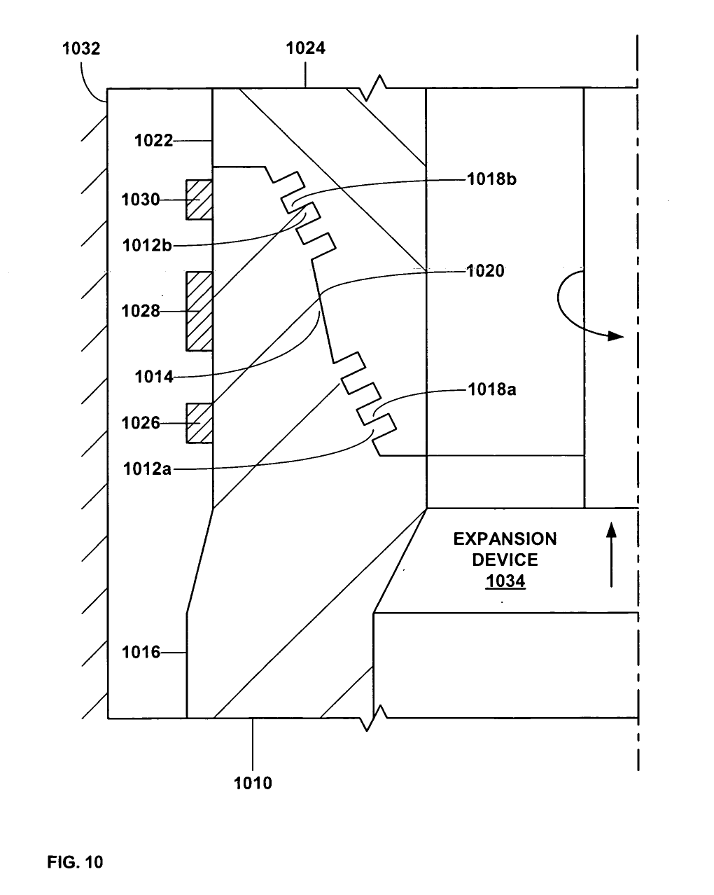

Referring to FIG. 10, in an exemplary embodiment, a first tubular member 1010 includes internally threaded connections, 1012a and 1012b, spaced apart by a non-threaded internal surface 1014, at an end portion 1016. Externally threaded connections, 1018a and 1018b, spaced apart by a non-threaded external surface 1020, of an end portion 1022 of a second tubular member 1024 are threadably coupled to the internally threaded connections, 1012a and 1012b, respectively, of the end portion 1022 of the first tubular member 1024.

First, second, and/or third tubular sleeves, 1026, 1028, and 1030, are coupled the external surface of the first tubular member 1010 in opposing relation to the threaded connection formed by the internal and external threads, 1012a and 1018a, the interface between the non-threaded surfaces, 1014 and 1020, and the threaded connection formed by the internal and external threads, 1012b and 1018b, respectively.

The internally threaded connections, 1012a and 1012b, of the end portion 1016 of the first tubular member 1010 are box connections, and the externally threaded connections, 1018a and 1018b, of the end portion 1022 of the second tubular member 1024 are pin connections.

The first and second tubular members 1010 and 1024, and the tubular sleeves 1026, 1028, and/or 1030, may then be positioned within another structure 1032 such as, for example, a wellbore, and radially expanded and plastically deformed, for example, by displacing and/or rotating an expansion device 1034 through and/or within the interiors of the first and second tubular members.

During the radial expansion and plastic deformation of the first and second tubular members 1010 and 1024, the tubular sleeves 1026, 1028 and/or 1030 are also radially expanded and plastically deformed. In an exemplary embodiment, as a result, the tubular sleeves 1026, 1028, and/or 1030 are maintained in circumferential tension and the end portions 1016 and 1022, of the first and second tubular members 1010 and 1024, may be maintained in circumferential compression.

The sleeve 1026, 1028, and/or 1030 may, for example, be secured to the first tubular member 1010 by a heat shrink fit.

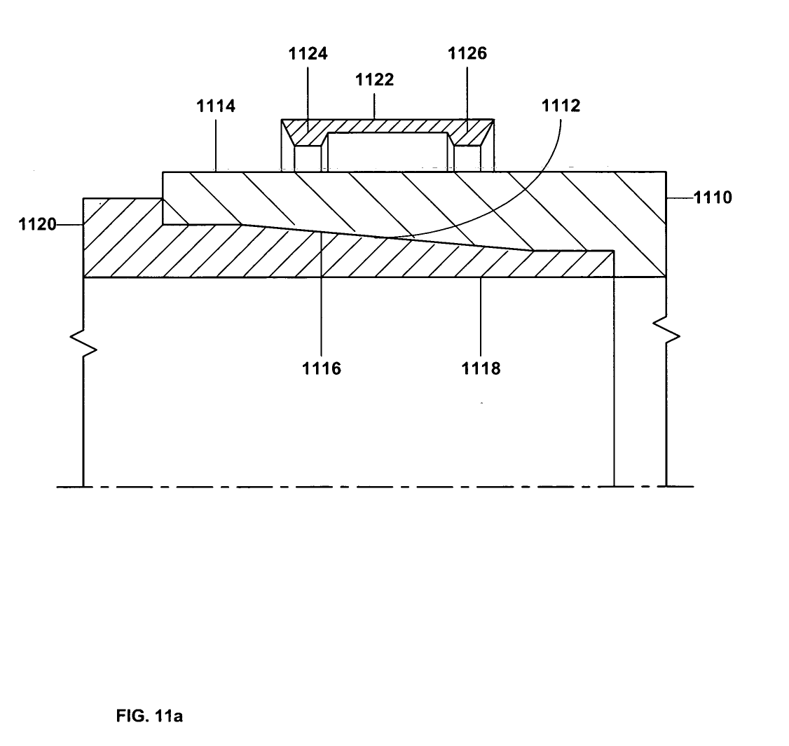

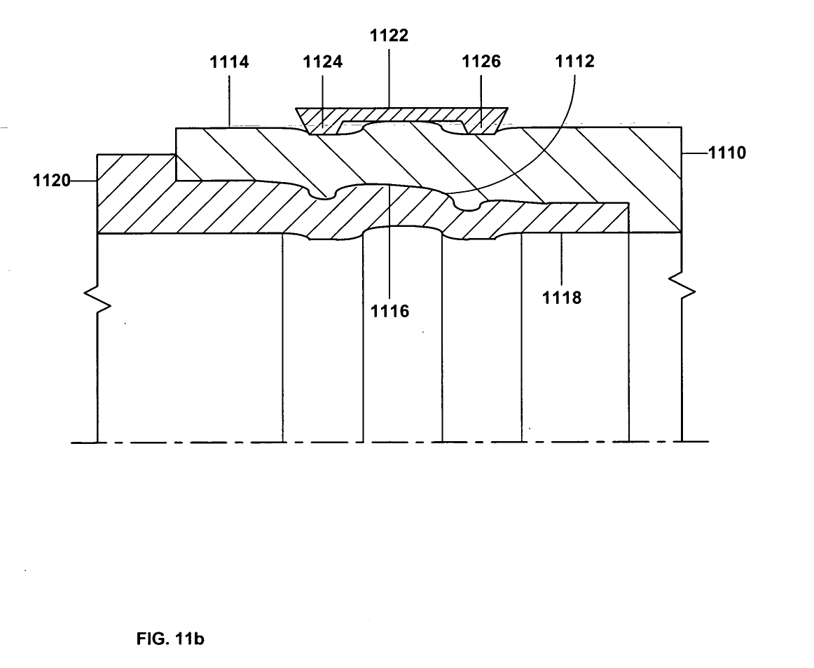

Referring to FIG. 11a, in an exemplary embodiment, a first tubular member 1110 includes an internally threaded connection 1112 at an end portion 1114. An externally threaded connection 1116 of an end portion 1118 of a second tubular member 1120 are threadably coupled to the internally threaded connection 1112 of the end portion 1114 of the first tubular member 1110.

The internally threaded connection 1112 of the end portion 1114 of the first tubular member 1110 is a box connection, and the externally threaded connection 1116 of the end portion 1118 of the second tubular member 1120 is a pin connection.

A tubular sleeve 1122 including internal flanges 1124 and 1126 is positioned proximate and surrounding the end portion 1114 of the first tubular member 1110. As illustrated in FIG. 11b, the tubular sleeve 1122 is then forced into engagement with the external surface of the end portion 1114 of the first tubular member 1110 in a conventional manner. As a result, the end portions, 1114 and 1118, of the first and second tubular members, 1110 and 1120, are upset in an undulating fashion.

The first and second tubular members 1110 and 1120, and the tubular sleeve 11122, may then be positioned within another structure such as, for example, a wellbore, and radially expanded and plastically deformed, for example, by displacing and/or rotating an expansion device through and/or within the interiors of the first and second tubular members.

During the radial expansion and plastic deformation of the first and second tubular members 1110 and 1120, the tubular sleeve 1122 is also radially expanded and plastically deformed. In an exemplary embodiment, as a result, the tubular sleeve 1122 is maintained in circumferential tension and the end portions 1114 and 1118, of the first and second tubular members 1110 and 1120, may be maintained in circumferential compression.

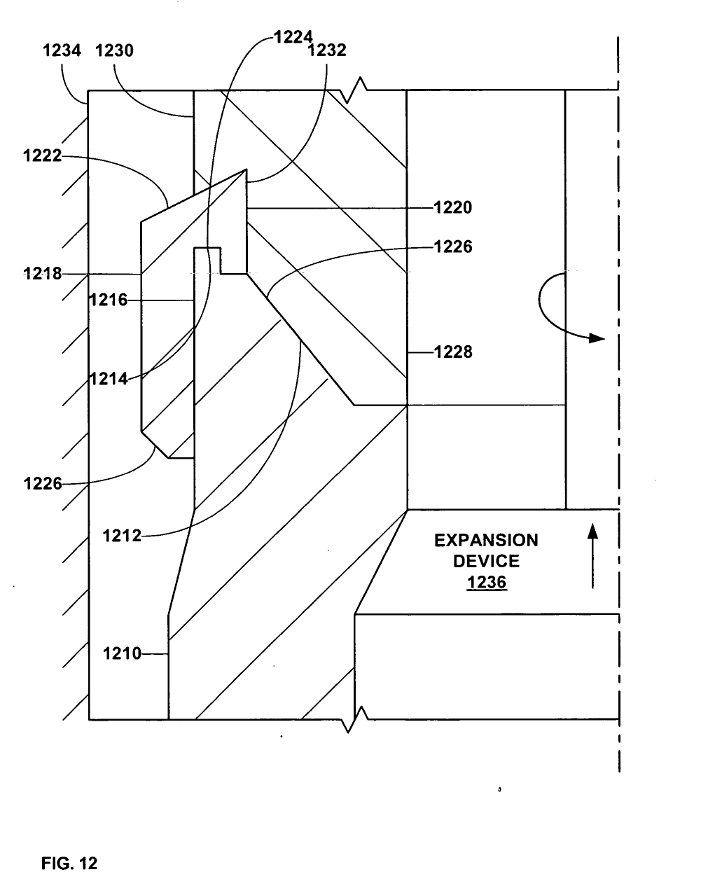

Referring to FIG. 12, in an exemplary embodiment, a first tubular member 1210 includes an internally threaded connection 1212 and an annular projection 1214 at an end portion 1216.

A first end of a tubular sleeve 1218 that includes an internal flange 1220 having a tapered portion 1222 and an annular recess 1224 for receiving the annular projection 1214 of the first tubular member 1210, and a second end that includes a tapered portion 1226, is then mounted upon and receives the end portion 1216 of the first tubular member 1210.

In an exemplary embodiment, the end portion 1216 of the first tubular member 1210 abuts one side of the internal flange 1220 of the tubular sleeve 1218 and the annular projection 1214 of the end portion of the first tubular member mates with and is received within the annular recess 1224 of the internal flange of the tubular sleeve, and the internal diameter of the internal flange 1220 of the tubular sleeve 1218 is substantially equal to or greater than the maximum internal diameter of the internally threaded connection 1212 of the end portion 1216 of the first tubular member 1210. An externally threaded connection 1226 of an end portion 1228 of a second tubular member 1230 having an annular recess 1232 is then positioned within the tubular sleeve 1218 and threadably coupled to the internally threaded connection 1212 of the end portion 1216 of the first tubular member 1210. In an exemplary embodiment, the internal flange 1232 of the tubular sleeve 1218 mates with and is received within the annular recess 1232 of the end portion 1228 of the second tubular member 1230. Thus, the tubular sleeve 1218 is coupled to and surrounds the external surfaces of the first and second tubular members, 1210 and 1228.

The internally threaded connection 1212 of the end portion 1216 of the first tubular member 1210 is a box connection, and the externally threaded connection 1226 of the end portion 1228 of the second tubular member 1230 is a pin connection. In an exemplary embodiment, the internal diameter of the tubular sleeve 1218 is at least approximately 0.020″ greater than the outside diameters of the first and second tubular members, 1210 and 1230. In this manner, during the threaded coupling of the first and second tubular members, 1210 and 1230, fluidic materials within the first and second tubular members may be vented from the tubular members.

As illustrated in FIG. 12, the first and second tubular members, 110 and 128, and the tubular sleeve 116 may be positioned within another structure 132 such as, for example, a cased or uncased wellbore, and radially expanded and plastically deformed, for example, by displacing and/or rotating a conventional expansion device 1236 within and/or through the interiors of the first and second tubular members. The tapered portions, 1222 and 1226, of the tubular sleeve 1218 facilitate the insertion and movement of the first and second tubular members within and through the structure 1234, and the movement of the expansion device 1236 through the interiors of the first and second tubular members, 1210 and 1230, may be from top to bottom or from bottom to top.

During the radial expansion and plastic deformation of the first and second tubular members, 1210 and 1230, the tubular sleeve 1218 is also radially expanded and plastically deformed. As a result, the tubular sleeve 1218 may be maintained in circumferential tension and the end portions, 1216 and 1228, of the first and second tubular members, 1210 and 1230, may be maintained in circumferential compression.

Sleeve 1216 increases the axial compression loading of the connection between tubular members 1210 and 1230 before and after expansion by the expansion device 1236. Sleeve 1216 may be secured to tubular members 1210 and 1230, for example, by a heat shrink fit.

In several alternative embodiments, the first and second tubular members, 1210 and 1230, are radially expanded and plastically deformed using other conventional methods for radially expanding and plastically deforming tubular members such as, for example, internal pressurization, hydroforming, and/or roller expansion devices and/or any one or combination of the conventional commercially available expansion products and services available from Baker Hughes, Weatherford International, and/or Enventure Global Technology L.L.C.

The use of the tubular sleeve 1216 during (a) the coupling of the first tubular member 1210 to the second tubular member 1230, (b) the placement of the first and second tubular members in the structure 1234, and (c) the radial expansion and plastic deformation of the first and second tubular members provides a number of significant benefits. For example, the tubular sleeve 1216 protects the exterior surfaces of the end portions, 1216 and 1228, of the first and second tubular members, 1210 and 1230, during handling and insertion of the tubular members within the structure 1234. In this manner, damage to the exterior surfaces of the end portions, 1216 and 1228, of the first and second tubular members, 1210 and 1230, is avoided that could otherwise result in stress concentrations that could cause a catastrophic failure during subsequent radial expansion operations. Furthermore, the tubular sleeve 1216 provides an alignment guide that facilitates the insertion and threaded coupling of the second tubular member 1230 to the first tubular member 1210. In this manner, misalignment that could result in damage to the threaded connections, 1212 and 1228, of the first and second tubular members, 1210 and 1230, may be avoided. In addition, during the relative rotation of the second tubular member with respect to the first tubular member, required during the threaded coupling of the first and second tubular members, the tubular sleeve 1216 provides an indication of to what degree the first and second tubular members are threadably coupled. For example, if the tubular sleeve 1216 can be easily rotated, that would indicate that the first and second tubular members, 1210 and 1230, are not fully threadably coupled and in intimate contact with the internal flange 1220 of the tubular sleeve. Furthermore, the tubular sleeve 1216 may prevent crack propagation during the radial expansion and plastic deformation of the first and second tubular members, 1210 and 1230. In this manner, failure modes such as, for example, longitudinal cracks in the end portions, 1216 and 1228, of the first and second tubular members may be limited in severity or eliminated all together. In addition, after completing the radial expansion and plastic deformation of the first and second tubular members, 1210 and 1230, the tubular sleeve 1216 may provide a fluid tight metal-to-metal seal between interior surface of the tubular sleeve 1216 and the exterior surfaces of the end portions, 1216 and 1228, of the first and second tubular members. In this manner, fluidic materials are prevented from passing through the threaded connections, 1212 and 1226, of the first and second tubular members, 1210 and 1230, into the annulus between the first and second tubular members and the structure 1234. Furthermore, because, following the radial expansion and plastic deformation of the first and second tubular members, 1210 and 1230, the tubular sleeve 1216 may be maintained in circumferential tension and the end portions, 1216 and 1228, of the first and second tubular members, 1210 and 1230, may be maintained in circumferential compression, axial loads and/or torque loads may be transmitted through the tubular sleeve.

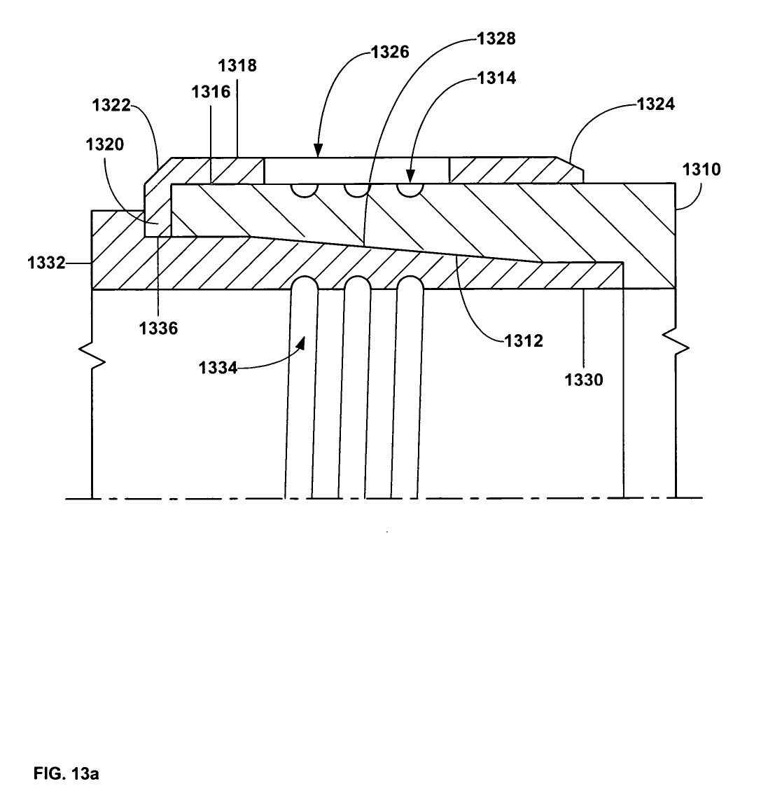

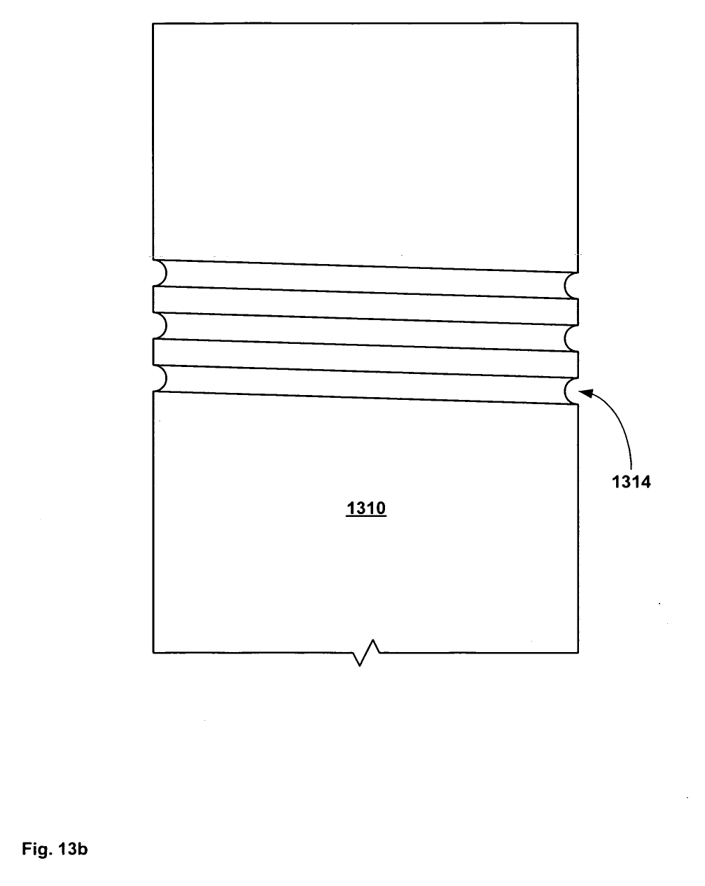

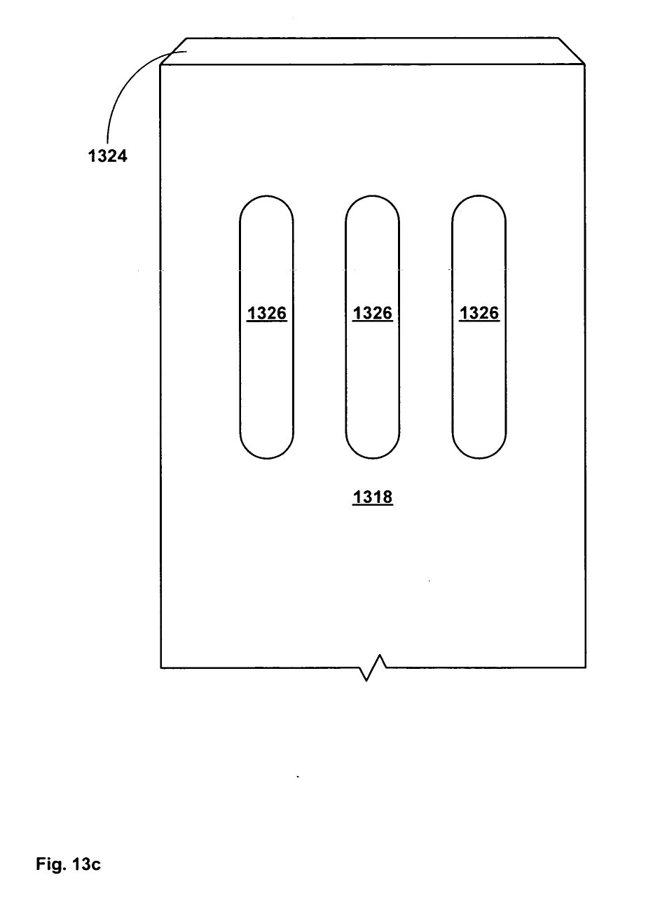

Referring to FIGS. 13a, 13b, and 13c, in an exemplary embodiment, a first tubular member 1310 includes an internally threaded connection 1312 and one or more external grooves 1314 at an end portion 1316.

A first end of a tubular sleeve 1318 that includes an internal flange 1320 and a tapered portion 1322, a second end that includes a tapered portion 1324, and an intermediate portion that includes one or more longitudinally aligned openings 1326, is then mounted upon and receives the end portion 1316 of the first tubular member 1310.

In an exemplary embodiment, the end portion 1316 of the first tubular member 1310 abuts one side of the internal flange 1320 of the tubular sleeve 1318, and the internal diameter of the internal flange 1320 of the tubular sleeve 1316 is substantially equal to or greater than the maximum internal diameter of the internally threaded connection 1312 of the end portion 1316 of the first tubular member 1310. An externally threaded connection 1328 of an end portion 1330 of a second tubular member 1332 that includes one or more internal grooves 1334 is then positioned within the tubular sleeve 1318 and threadably coupled to the internally threaded connection 1312 of the end portion 1316 of the first tubular member 1310. In an exemplary embodiment, the internal flange 1320 of the tubular sleeve 1318 mates with and is received within an annular recess 1336 defined in the end portion 1330 of the second tubular member 1332. Thus, the tubular sleeve 1318 is coupled to and surrounds the external surfaces of the first and second tubular members, 1310 and 1332.

The first and second tubular members, 1310 and 1332, and the tubular sleeve 1318 may be positioned within another structure such as, for example, a cased or uncased wellbore, and radially expanded and plastically deformed, for example, by displacing and/or rotating a conventional expansion device within and/or through the interiors of the first and second tubular members. The tapered portions, 1322 and 1324, of the tubular sleeve 1318 facilitate the insertion and movement of the first and second tubular members within and through the structure, and the movement of the expansion device through the interiors of the first and second tubular members, 1310 and 1332, may be from top to bottom or from bottom to top.

During the radial expansion and plastic deformation of the first and second tubular members, 1310 and 1332, the tubular sleeve 1318 is also radially expanded and plastically deformed. As a result, the tubular sleeve 1318 may be maintained in circumferential tension and the end portions, 1316 and 1330, of the first and second tubular members, 1310 and 1332, may be maintained in circumferential compression.

Sleeve 1316 increases the axial compression loading of the connection between tubular members 1310 and 1332 before and after expansion by the expansion device. The sleeve 1318 may be secured to tubular members 1310 and 1332, for example, by a heat shrink fit.

During the radial expansion and plastic deformation of the first and second tubular members, 1310 and 1332, the grooves 1314 and/or 1334 and/or the openings 1326 provide stress concentrations that in turn apply added stress forces to the mating threads of the threaded connections, 1312 and 1328. As a result, during and after the radial expansion and plastic deformation of the first and second tubular members, 1310 and 1332, the mating threads of the threaded connections, 1312 and 1328, are maintained in metal to metal contact thereby providing a fluid and gas tight connection. In an exemplary embodiment, the orientations of the grooves 1314 and/or 1334 and the openings 1326 are orthogonal to one another. In an exemplary embodiment, the grooves 1314 and/or 1334 are helical grooves.

In several alternative embodiments, the first and second tubular members, 1310 and 1332, are radially expanded and plastically deformed using other conventional methods for radially expanding and plastically deforming tubular members such as, for example, internal pressurization, hydroforming, and/or roller expansion devices and/or any one or combination of the conventional commercially available expansion products and services available from Baker Hughes, Weatherford International, and/or Enventure Global Technology L.L.C.

The use of the tubular sleeve 1318 during (a) the coupling of the first tubular member 1310 to the second tubular member 1332, (b) the placement of the first and second tubular members in the structure, and (c) the radial expansion and plastic deformation of the first and second tubular members provides a number of significant benefits. For example, the tubular sleeve 1318 protects the exterior surfaces of the end portions, 1316 and 1330, of the first and second tubular members, 1310 and 1332, during handling and insertion of the tubular members within the structure. In this manner, damage to the exterior surfaces of the end portions, 1316 and 1330, of the first and second tubular members, 1310 and 1332, is avoided that could otherwise result in stress concentrations that could cause a catastrophic failure during subsequent radial expansion operations. Furthermore, the tubular sleeve 1318 provides an alignment guide that facilitates the insertion and threaded coupling of the second tubular member 1332 to the first tubular member 1310. In this manner, misalignment that could result in damage to the threaded connections, 1312 and 1328, of the first and second tubular members, 1310 and 1332, may be avoided. In addition, during the relative rotation of the second tubular member with respect to the first tubular member, required during the threaded coupling of the first and second tubular members, the tubular sleeve 1316 provides an indication of to what degree the first and second tubular members are threadably coupled. For example, if the tubular sleeve 1318 can be easily rotated, that would indicate that the first and second tubular members, 1310 and 1332, are not fully threadably coupled and in intimate contact with the internal flange 1320 of the tubular sleeve. Furthermore, the tubular sleeve 1318 may prevent crack propagation during the radial expansion and plastic deformation of the first and second tubular members, 1310 and 1332. In this manner, failure modes such as, for example, longitudinal cracks in the end portions, 1316 and 1330, of the first and second tubular members may be limited in severity or eliminated all together. In addition, after completing the radial expansion and plastic deformation of the first and second tubular members, 1310 and 1332, the tubular sleeve 1318 may provide a fluid and gas tight metal-to-metal seal between interior surface of the tubular sleeve 1318 and the exterior surfaces of the end portions, 1316 and 1330, of the first and second tubular members. In this manner, fluidic materials are prevented from passing through the threaded connections, 1312 and 1330, of the first and second tubular members, 1310 and 1332, into the annulus between the first and second tubular members and the structure. Furthermore, because, following the radial expansion and plastic deformation of the first and second tubular members, 1310 and 1332, the tubular sleeve 1318 may be maintained in circumferential tension and the end portions, 1316 and 1330, of the first and second tubular members, 1310 and 1332, may be maintained in circumferential compression, axial loads and/or torque loads may be transmitted through the tubular sleeve.

In several exemplary embodiments, the first and second tubular members are radially expanded and plastically deformed using the expansion device in a conventional manner and/or using one or more of the methods and apparatus disclosed in one or more of the following: The present application is related to the following: (1) U.S. patent application Ser. No. 09/454,139, attorney docket no. 25791.03.02, filed on Dec. 3, 1999, (2) U.S. patent application Ser. No. 09/510,913, attorney docket no. 25791.7.02, filed on Feb. 23, 2000, (3) U.S. patent application Ser. No. 09/502,350, attorney docket no. 25791.8.02, filed on Feb. 10, 2000, (4) U.S. patent application Ser. No. 09/440,338, attorney docket no. 25791.9.02, filed on Nov. 15, 1999, (5) U.S. patent application Ser. No. 09/523,460, attorney docket no. 25791.11.02, filed on Mar. 10, 2000, (6) U.S. patent application Ser. No. 09/512,895, attorney docket no. 25791.12.02, filed on Feb. 24, 2000, (7) U.S. patent application Ser. No. 09/511,941, attorney docket no. 25791.16.02, filed on Feb. 24, 2000, (8) U.S. patent application serial no. 09/588,946, attorney docket no. 25791.17.02, filed on Jun. 7, 2000, (9) U.S. patent application Ser. No. 09/559,122, attorney docket no. 25791.23.02, filed on Apr. 26, 2000, (10) PCT patent application serial no. PCT/US00/18635, attorney docket no. 25791.25.02, filed on Jul. 9, 2000, (11) U.S. provisional patent application Ser. No. 60/162,671, attorney docket no. 25791.27, filed on Nov. 1, 1999, (12) U.S. provisional patent application Ser. No. 60/154,047, attorney docket no. 25791.29, filed on Sep. 16, 1999, (13) U.S. provisional patent application Ser. No. 60/159,082, attorney docket no. 25791.34, filed on Oct. 12, 1999, (14) U.S. provisional patent application Ser. No. 60/159,039, attorney docket no. 25791.36, filed on Oct. 12, 1999, (15) U.S. provisional patent application Ser. No. 60/159,033, attorney docket no. 25791.37, filed on Oct. 12, 1999, (16) U.S. provisional patent application Ser. No. 60/212,359, attorney docket no. 25791.38, filed on Jun. 19, 2000, (17) U.S. provisional patent application Ser. No. 60/165,228, attorney docket no. 25791.39, filed on Nov. 12, 1999, (18) U.S. provisional patent application Ser. No. 60/221,443, attorney docket no. 25791.45, filed on Jul. 28, 2000, (19) U.S. provisional patent application Ser. No. 60/221,645, attorney docket no. 25791.46, filed on Jul. 28, 2000, (20) U.S. provisional patent application Ser. No. 60/233,638, attorney docket no. 25791.47, filed on Sep. 18, 2000, (21) U.S. provisional patent application Ser. No. 60/237,334, attorney docket no. 25791.48, filed on Oct. 2, 2000, (22) U.S. provisional patent application Ser. No. 60/270,007, attorney docket no. 25791.50, filed on Feb. 20, 2001, (23) U.S. provisional patent application Ser. No. 60/262,434, attorney docket no. 25791.51, filed on Jan. 17, 2001, (24) U.S. provisional patent application Ser. No. 60/259,486, attorney docket no. 25791.52, filed on Jan. 3, 2001, (25) U.S. provisional patent application Ser. No. 60/303,740, attorney docket no. 25791.61, filed on Jul. 6, 2001, (26) U.S. provisional patent application Ser. No. 60/313,453, attorney docket no. 25791.59, filed on Aug. 20, 2001, (27) U.S. provisional patent application Ser. No. 60/317,985, attorney docket no. 25791.67, filed on Sep. 6, 2001, (28) U.S. provisional patent application Ser. No. 60/3318,386, attorney docket no. 25791.67.02, filed on Sep. 10, 2001, (29) U.S. utility patent application Ser. No. 09/969,922, attorney docket no. 25791.69, filed on Oct. 3, 2001, (30) U.S. utility patent application Ser. No. 10/016,467, attorney docket no. 25791.70, filed on Dec. 10, 2001, (31) U.S. provisional patent application Ser. No. 60/343,674, attorney docket no. 25791.68, filed on Dec. 27, 2001; and (32) U.S. provisional patent application Ser. No. 60/346,309, attorney docket no. 25791.92, filed on Jan. 7, 2002, (33) U.S. utility patent application Ser. No. ______, attorney docket number 25791.378, filed on Aug. 16, 2005, (34) U.S. utility patent application Ser. No. ______, attorney docket number 25791.379, filed on Aug. 16, 2005, (35) U.S. utility patent application Ser. No. ______, attorney docket number 25791.380, filed on Aug. 16, 2005, (36) U.S. utility patent application Ser. No. ______, attorney docket number 25791.381, filed on Aug. 16, 2005, (37) U.S. utility patent application Ser. No. ______, attorney docket number 25791.382, filed on Aug. 16, 2005, (38) U.S. utility patent application Ser. No. ______, attorney docket number 25791.185.05, filed on Aug. 16, 2005, the disclosures of which are incorporated herein by reference.

In several exemplary embodiments, the teachings of the present disclosure are combined with one or more of the teachings disclosed in FR 2 841 626, filed on Jun. 28, 2002, and published on Jan. 2, 2004, the disclosure of which is incorporated herein by reference.

A radially expandable multiple tubular member apparatus has been described that includes a first tubular member; a second tubular member engaged with the first tubular member forming a joint; a sleeve overlapping and coupling the first and second tubular members at the joint; the sleeve having opposite tapered ends and a flange engaged in a recess formed in an adjacent tubular member; and one of the tapered ends being a surface formed on the flange. In an exemplary embodiment, the recess includes a tapered wall in mating engagement with the tapered end formed on the flange. In an exemplary embodiment, the sleeve includes a flange at each tapered end and each tapered end is formed on a respective flange. In an exemplary embodiment, each tubular member includes a recess. In an exemplary embodiment, each flange is engaged in a respective one of the recesses. In an exemplary embodiment, each recess includes a tapered wall in mating engagement with the tapered end formed on a respective one of the flanges.

A method of joining radially expandable multiple tubular members has also been described that includes providing a first tubular member; engaging a second tubular member with the first tubular member to form a joint; providing a sleeve having opposite tapered ends and a flange, one of the tapered ends being a surface formed on the flange; and mounting the sleeve for overlapping and coupling the first and second tubular members at the joint, wherein the flange is engaged in a recess formed in an adjacent one of the tubular members. In an exemplary embodiment, the method further includes providing a tapered wall in the recess for mating engagement with the tapered end formed on the flange. In an exemplary embodiment, the method further includes providing a flange at each tapered end wherein each tapered end is formed on a respective flange. In an exemplary embodiment, the method further includes providing a recess in each tubular member. In an exemplary embodiment, the method further includes engaging each flange in a respective one of the recesses. In an exemplary embodiment, the method further includes providing a tapered wall in each recess for mating engagement with the tapered end formed on a respective one of the flanges.

A radially expandable multiple tubular member apparatus has been described that includes a first tubular member; a second tubular member engaged with the first tubular member forming a joint; and a sleeve overlapping and coupling the first and second tubular members at the joint; wherein at least a portion of the sleeve is comprised of a frangible material.

A radially expandable multiple tubular member apparatus has been described that includes a first tubular member; a second tubular member engaged with the first tubular member forming a joint; and a sleeve overlapping and coupling the first and second tubular members at the joint; wherein the wall thickness of the sleeve is variable.

A method of joining radially expandable multiple tubular members has been described that includes providing a first tubular member; engaging a second tubular member with the first tubular member to form a joint; providing a sleeve comprising a frangible material; and mounting the sleeve for overlapping and coupling the first and second tubular members at the joint.

A method of joining radially expandable multiple tubular members has been described that includes providing a first tubular member; engaging a second tubular member with the first tubular member to form a joint; providing a sleeve comprising a variable wall thickness; and mounting the sleeve for overlapping and coupling the first and second tubular members at the joint.

An expandable tubular assembly has been described that includes a first tubular member; a second tubular member coupled to the first tubular member; and means for increasing the axial compression loading capacity of the coupling between the first and second tubular members before and after a radial expansion and plastic deformation of the first and second tubular members.

An expandable tubular assembly has been described that includes a first tubular member; a second tubular member coupled to the first tubular member; and means for increasing the axial tension loading capacity of the coupling between the first and second tubular members before and after a radial expansion and plastic deformation of the first and second tubular members.

An expandable tubular assembly has been described that includes a first tubular member; a second tubular member coupled to the first tubular member; and means for increasing the axial compression and tension loading capacity of the coupling between the first and second tubular members before and after a radial expansion and plastic deformation of the first and second tubular members.

An expandable tubular assembly has been described that includes a first tubular member; a second tubular member coupled to the first tubular member; and means for avoiding stress risers in the coupling between the first and second tubular members before and after a radial expansion and plastic deformation of the first and second tubular members.

An expandable tubular assembly has been described that includes a first tubular member; a second tubular member coupled to the first tubular member; and means for inducing stresses at selected portions of the coupling between the first and second tubular members before and after a radial expansion and plastic deformation of the first and second tubular members.

In several exemplary embodiments of the apparatus described above, the sleeve is circumferentially tensioned; and wherein the first and second tubular members are circumferentially compressed.

In several exemplary embodiments of the method described above, the method further includes maintaining the sleeve in circumferential tension; and maintaining the first and second tubular members in circumferential compression before, during, and/or after the radial expansion and plastic deformation of the first and second tubular members.

An expandable tubular assembly has been described that includes a first tubular member, a second tubular member coupled to the first tubular member, a first threaded connection for coupling a portion of the first and second tubular members, a second threaded connection spaced apart from the first threaded connection for coupling another portion of the first and second tubular members, a tubular sleeve coupled to and receiving end portions of the first and second tubular members, and a sealing element positioned between the first and second spaced apart threaded connections for sealing an interface between the first and second tubular member, wherein the sealing element is positioned within an annulus defined between the first and second tubular members. In an exemplary embodiment, the annulus is at least partially defined by an irregular surface. In an exemplary embodiment, the annulus is at least partially defined by a toothed surface. In an exemplary embodiment, the sealing element comprises an elastomeric material. In an exemplary embodiment, the sealing element comprises a metallic material. In an exemplary embodiment, the sealing element comprises an elastomeric and a metallic material.

A method of joining radially expandable multiple tubular members has been described that includes providing a first tubular member, providing a second tubular member, providing a sleeve, mounting the sleeve for overlapping and coupling the first and second tubular members, threadably coupling the first and second tubular members at a first location, threadably coupling the first and second tubular members at a second location spaced apart from the first location, and sealing an interface between the first and second tubular members between the first and second locations using a compressible sealing element. In an exemplary embodiment, the sealing element includes an irregular surface. In an exemplary embodiment, the sealing element includes a toothed surface. In an exemplary embodiment, the sealing element comprises an elastomeric material. In an exemplary embodiment, the sealing element comprises a metallic material. In an exemplary embodiment, the sealing element comprises an elastomeric and a metallic material.

An expandable tubular assembly has been described that includes a first tubular member, a second tubular member coupled to the first tubular member, a first threaded connection for coupling a portion of the first and second tubular members, a second threaded connection spaced apart from the first threaded connection for coupling another portion of the first and second tubular members, and a plurality of spaced apart tubular sleeves coupled to and receiving end portions of the first and second tubular members. In an exemplary embodiment, at least one of the tubular sleeves is positioned in opposing relation to the first threaded connection; and wherein at least one of the tubular sleeves is positioned in opposing relation to the second threaded connection. In an exemplary embodiment, at least one of the tubular sleeves is not positioned in opposing relation to the first and second threaded connections.

A method of joining radially expandable multiple tubular members has been described that includes providing a first tubular member, providing a second tubular member, threadably coupling the first and second tubular members at a first location, threadably coupling the first and second tubular members at a second location spaced apart from the first location, providing a plurality of sleeves, and mounting the sleeves at spaced apart locations for overlapping and coupling the first and second tubular members. In an exemplary embodiment, at least one of the tubular sleeves is positioned in opposing relation to the first threaded coupling; and wherein at least one of the tubular sleeves is positioned in opposing relation to the second threaded coupling. In an exemplary embodiment, at least one of the tubular sleeves is not positioned in opposing relation to the first and second threaded couplings.

An expandable tubular assembly has been described that includes a first tubular member, a second tubular member coupled to the first tubular member, and a plurality of spaced apart tubular sleeves coupled to and receiving end portions of the first and second tubular members.

A method of joining radially expandable multiple tubular members has been described that includes providing a first tubular member, providing a second tubular member, providing a plurality of sleeves, coupling the first and second tubular members, and mounting the sleeves at spaced apart locations for overlapping and coupling the first and second tubular members.

An expandable tubular assembly has been described that includes a first tubular member, a second tubular member coupled to the first tubular member, a threaded connection for coupling a portion of the first and second tubular members, and a tubular sleeves coupled to and receiving end portions of the first and second tubular members, wherein at least a portion of the threaded connection is upset. In an exemplary embodiment, at least a portion of tubular sleeve penetrates the first tubular member.

A method of joining radially expandable multiple tubular members has been described that includes providing a first tubular member, providing a second tubular member, threadably coupling the first and second tubular members, and upsetting the threaded coupling. In an exemplary embodiment, the first tubular member further comprises an annular extension extending therefrom, and the flange of the sleeve defines an annular recess for receiving and mating with the annular extension of the first tubular member. In an exemplary embodiment, the first tubular member further comprises an annular extension extending therefrom; and the flange of the sleeve defines an annular recess for receiving and mating with the annular extension of the first tubular member.

A radially expandable multiple tubular member apparatus has been described that includes a first tubular member, a second tubular member engaged with the first tubular member forming a joint, a sleeve overlapping and coupling the first and second tubular members at the joint, and one or more stress concentrators for concentrating stresses in the joint. In an exemplary embodiment, one or more of the stress concentrators comprises one or more external grooves defined in the first tubular member. In an exemplary embodiment, one or more of the stress concentrators comprises one or more internal grooves defined in the second tubular member. In an exemplary embodiment, one or more of the stress concentrators comprises one or more openings defined in the sleeve. In an exemplary embodiment, one or more of the stress concentrators comprises one or more external grooves defined in the first tubular member; and one or more of the stress concentrators comprises one or more internal grooves defined in the second tubular member. In an exemplary embodiment, one or more of the stress concentrators comprises one or more external grooves defined in the first tubular member; and one or more of the stress concentrators comprises one or more openings defined in the sleeve. In an exemplary embodiment, one or more of the stress concentrators comprises one or more internal grooves defined in the second tubular member; and one or more of the stress concentrators comprises one or more openings defined in the sleeve. In an exemplary embodiment, one or more of the stress concentrators comprises one or more external grooves defined in the first tubular member; wherein one or more of the stress concentrators comprises one or more internal grooves defined in the second tubular member; and wherein one or more of the stress concentrators comprises one or more openings defined in the sleeve.

A method of joining radially expandable multiple tubular members has been described that includes providing a first tubular member, engaging a second tubular member with the first tubular member to form a joint, providing a sleeve having opposite tapered ends and a flange, one of the tapered ends being a surface formed on the flange, and concentrating stresses within the joint. In an exemplary embodiment, concentrating stresses within the joint comprises using the first tubular member to concentrate stresses within the joint. In an exemplary embodiment, concentrating stresses within the joint comprises using the second tubular member to concentrate stresses within the joint. In an exemplary embodiment, concentrating stresses within the joint comprises using the sleeve to concentrate stresses within the joint. In an exemplary embodiment, concentrating stresses within the joint comprises using the first tubular member and the second tubular member to concentrate stresses within the joint. In an exemplary embodiment, concentrating stresses within the joint comprises using the first tubular member and the sleeve to concentrate stresses within the joint. In an exemplary embodiment, concentrating stresses within the joint comprises using the second tubular member and the sleeve to concentrate stresses within the joint. In an exemplary embodiment, concentrating stresses within the joint comprises using the first tubular member, the second tubular member, and the sleeve to concentrate stresses within the joint.

A system for radially expanding and plastically deforming a first tubular member coupled to a second tubular member by a mechanical connection has been described that includes means for radially expanding the first and second tubular members, and means for maintaining portions of the first and second tubular member in circumferential compression following the radial expansion and plastic deformation of the first and second tubular members.

A system for radially expanding and plastically deforming a first tubular member coupled to a second tubular member by a mechanical connection has been described that includes means for radially expanding the first and second tubular members; and means for concentrating stresses within the mechanical connection during the radial expansion and plastic deformation of the first and second tubular members.

A system for radially expanding and plastically deforming a first tubular member coupled to a second tubular member by a mechanical connection has been described that includes means for radially expanding the first and second tubular members; means for maintaining portions of the first and second tubular member in circumferential compression following the radial expansion and plastic deformation of the first and second tubular members; and means for concentrating stresses within the mechanical connection during the radial expansion and plastic deformation of the first and second tubular members.

It is understood that variations may be made in the foregoing without departing from the scope of the invention. For example, the teachings of the present illustrative embodiments may be used to provide a wellbore casing, a pipeline, or a structural support. Furthermore, the elements and teachings of the various illustrative embodiments may be combined in whole or in part in some or all of the illustrative embodiments.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed is:

1. An expandable tubular assembly, comprising:
a first tubular member;
a second tubular member coupled to the first tubular member; and
means for increasing the axial compression loading capacity of the coupling between the first and second tubular members before and after a radial expansion and plastic deformation of the first and second tubular members.

2. An expandable tubular assembly, comprising:
a first tubular member;
a second tubular member coupled to the first tubular member; and
means for increasing the axial tension loading capacity of the coupling between the first and second tubular members before and after a radial expansion and plastic deformation of the first and second tubular members.

3. An expandable tubular assembly, comprising:
a first tubular member;
a second tubular member coupled to the first tubular member; and
means for increasing the axial compression and tension loading capacity of the coupling between the first and second tubular members before and after a radial expansion and plastic deformation of the first and second tubular members.

4. An expandable tubular assembly, comprising:
a first tubular member;
a second tubular member coupled to the first tubular member; and
means for avoiding stress risers in the coupling between the first and second tubular members before and after a radial expansion and plastic deformation of the first and second tubular members.

5. The assembly of claim 1, wherein the means for increasing the axial compression loading capacity of the coupling between the first and second tubular members before and after a radial expansion and plastic deformation of the first and second tubular members is circumferentially tensioned; and wherein the first and second tubular members are circumferentially compressed.

6. The assembly of claim 2, wherein the means for increasing the axial tension loading capacity of the coupling between the first and second tubular members before and after a radial expansion and plastic deformation of the first and second tubular members is circumferentially tensioned; and wherein the first and second tubular members are circumferentially compressed.

7. The assembly of claim 3, wherein the means for increasing the axial compression and tension loading capacity of the coupling between the first and second tubular members before and after a radial expansion and plastic deformation of the first and second tubular members is circumferentially tensioned; and wherein the first and second tubular members are circumferentially compressed.

8. The assembly of claim 4, wherein the means for avoiding stress risers in the coupling between the first and second tubular members before and after a radial expansion and plastic deformation of the first and second tubular members is circumferentially tensioned; and wherein the first and second tubular members are circumferentially compressed.

9. A system for radially expanding and plastically deforming a first tubular member coupled to a second tubular member by a mechanical connection, comprising:
means for radially expanding the first and second tubular members; and
means for maintaining portions of the first and second tubular member in circumferential compression following the radial expansion and plastic deformation of the first and second tubular members.

10. The expandable tubular assembly of claim 1, wherein the relative axial positions of the first and second tubular members is fixed.

11. The expandable tubular assembly of claim 2, wherein the relative axial positions of the first and second tubular members is fixed.

12. The expandable tubular assembly of claim 3, wherein the relative axial positions of the first and second tubular members is fixed.

13. The expandable tubular assembly of claim 4, wherein the relative axial positions of the first and second tubular members is fixed.
